(19) United States
(12) Patent Application Publication
(10) Pub. No.: US 2017/0289244 A1
(43) Pub. Date: Oct. 5, 2017

(54) SYSTEM AND METHOD FOR MODULAR COMMUNICATION

(71) Applicant: Hyuk Hoon SHIM, Seongnam-si (KR)

(72) Inventor: Hyuk Hoon SHIM, Seongnam-si (KR)

(73) Assignee: AKN KOREA INC, Seoul (KR)

(21) Appl. No.: 15/085,346

(22) Filed: Mar. 30, 2016

(51) Int. Cl. H04L 29/08; G06F 17/28; G10L 15/26; G06F 17/27

(52) U.S. Cl. CPC H04L 67/1074; G06F 17/275; G06F 17/289; G10L 15/265

(57) ABSTRACT

A modular system and method for a peer to peer communication solution. The modular method supports browser-to-mobile applications (vice versa) and mobile-to-mobile based applications communication. The modular communication allows users to utilize the solution with each module (block) dedicated to different independent aspects of the service in connection with other users. Content is in blocks that are rearrangeable, dynamic, shareble, custom-oriented based on user interaction. The solution focuses on one page application for ease of use. The communication architecture includes direct peer to peer data channel, utilization of server, and storage of information in database.

### BACKGROUND

### 1. Technical Field

The present invention relates to modular user interface which provides services to users via a peer to peer communication network, to thereby reduce the risk of information security exposure to unknown personnel. The present invention further secures communication data between users by becoming less dependent on server.

### 2. Description of Related Art

Conventional communication solutions require sign-up and download. Users are faced with solutions that provide multiple page navigations for interactions that creates inconvenience for the user having to flip from one screen to another. Many aspects of users' communications with another user is done in separate interaction i.e. call, video, sending files, etc. Users are concerned with security.

### SUMMARY

To solve the above-mentioned problems of the conventional communication solutions, the present invention is configured as follows. Modular communication on peer to peer network that does not require sign-up and download and instead, provides with 1 step process to gain connection with users. Modular content helps prioritize content based on user behavior. It provides a 1-page service for user interaction for ease of use. It scales well and provide stability. Users will be familiar with structure as each independent module on one page will cater to each aspect of the users' communication interaction needs with another user. Modular communication on a peer to peer network secures the information with less dependent on the server.

According to an aspect of the present invention, there is provided a system for modular communication comprising:

a display unit presenting UI data according to at least one module selected by the user;

an input unit by which said user inputs the data using a presented UI;

a processing unit processing said input data according to the interface of module;

a transmission unit said processed data is sent to another user; and

a receiving unit said processed data is received from another user.

Said module may comprise a combination of an predetermined unit module, it follows a protocol to interface with other unit module.

Said module may be a translation module that comprising:

a speech-to-text module converting speech input as text output;

a translation module translating the aforementioned text output; and

a text-to-speech module converting text input as speech output.

Said speech-to-text module may utilize the user's system settings or system environmental data of user terminal to detect the language to convert speech data into text data.

Said transmission unit sends the data via user command or by a predetermined protocol to another user.

Said module is a video media sharing module comprising:

a verification module that authenticates the share for access authorization,

said verification module that in the case of ungranted access, brings up the appropriate registration page within the module UI itself.

A verified or otherwise newly authenticated user's video playback may be synced.

Said video media sharing module may provide appropriate translated captions for the video media by analyzing the respective user's settings or system environment information of user terminal.

The display unit may display multiple modules on a single screen according to a predetermined protocol of the single screen dividing.

The display unit may display multiple modules, in the case the modules exceed the maximum threshold through the predetermined protocol of the single screen dividing, the modules are rearranged and or divided according to usage frequency and history.

According to another aspect of the present invention, there is provided a method for modular communication, comprising:

connecting communication service between a sender and a recipient;

receiving words spoken by the sender through a microphone during connection of the communication service;

displaying the words in a sender-side message box;

transmitting a message including the words from the sender to the recipient; and

displaying the message in a recipient-side message box.

The above method may further include:

translating the words into other language, and displaying the translated words in said other language in the sender-side message box.

The above method may further include:

translating the words into a designated language, and displaying the translated words in the designated language in the recipient-side message box.

According to another aspect of the present invention, there is provided a method for modular communication, comprising:

connecting communication service between a sender and a recipient;

receiving words spoken by the sender through a microphone; and

automatically displaying an original message including the words and a translated message including translated words corresponding to the words translated into other language.

According to another aspect of the present invention, there is provided a method for modular communication, comprising:

sharing a module for User1 with User2;

verifying whether the User2 is authenticated;

allowing sharing of the module if the User2 is authenticated; and

not allowing the sharing of the module if the User2 is not authenticated.

The above method may further include:

sending a request for subscription to the User2;

receiving an answer whether to allow the subscription from the User2;

processing the subscription of the User2 to the module and allowing the sharing of the module if the answer is allowing the subscription; and

not allowing the sharing of the module if the answer is not allowing the subscription.

According to another aspect of the present invention, there is provided a method for modular communication, comprising:

receiving a request for synchronization of module arrangement from User1;

receiving an answer whether to allow the module rearrangement from User2;

rearranging a module of the User2 such that the module arrangement of the User2 is same as the module arrangement of the User1 if the answer is allowing the module rearrangement; and

not rearranging the module of the User2 if the answer is not allowing the module rearrangement.

The above method further include:

verifying whether the module arrangement of the User1 or the User2 is changed; and

synchronizing the module arrangement of the User1 and that of the User2 with each other if the module arrangement of the User1 or the User2 is changed.

### BRIEF DESCRIPTION OF DRAWINGS

FIG. 1 is the flowchart of System and Method for Modular Communication that shows the user connects with another user in a peer to peer communication in browser-to-mobile (vice versa) or mobile-to-mobile applications method according to the present invention.

FIG. 2 is the flowchart of System and Method for Modular Communication that shows when user communicates with another user using video module, message module, and file share module in a peer to peer communication in browser-to-mobile (vice versa) or mobile-to-mobile applications method according to the present invention.

FIG. 3 is the flowchart of System and Method for Modular Communication that shows uses video module only in a peer to peer communication in browser-to-mobile (vice versa) or mobile to-mobile applications method according to the present invention.

FIG. 4 is the flowchart of System and Method for Modular Communication that shows video call module and message module in use in a peer to peer communication in browser-to-mobile (vice versa) or mobile-to-mobile applications method according to the present invention.

FIG. 5 is the flowchart of System and Method for Modular Communication that shows video call module with ability to turn off camera, message module, and file share module in use in a peer to peer communication in browser-to-mobile (vice versa) or mobile-to-mobile applications method according to the present invention.

FIG. 6 is the flowchart of System and Method for Modular Communication that shows only file share module in use in a peer to peer communication in browser-to-mobile (vice versa) or mobile-to-mobile applications method according to the present invention.

FIG. 7 is the flowchart of System and Method for Modular Communication that shows file share module interaction capabilities in a peer to peer communication in browser-to-mobile (vice versa) or mobile-to-mobile applications method according to the present invention.

FIG. 8 is the flowchart of System and Method for Modular Communication that shows screen share capabilities in the file share module in a peer to peer communication in browser-to-mobile (vice versa) or mobile-to-mobile applications method according to the present invention according to the present invention.

FIG. 9 is the flowchart of System and Method for Modular Communication that shows module layout interaction in all modules in a peer to peer communication in browser-to-mobile (vice versa) or mobile-to-mobile applications method according to the present invention.

FIG. 10 is the flowchart of System and Method for Modular Communication that shows notepad module in a peer to peer communication in browser-to-mobile (vice versa) or mobile-to-mobile applications method according to the present invention.

FIG. 11 is the flowchart of System and Method for Modular Communication that shows “speech-to-text” capability in the message module in a peer to peer communication in browser-to-mobile (vice versa) or mobile-to-mobile applications method according to the present invention.

FIG. 12 is the flowchart of System and Method for Modular Communication that shows “speech-to-text” capability in the message module with no video module in a peer to peer communication in browser-to-mobile (vice versa) or mobile-to-mobile applications method according to the present invention.

FIG. 13 is the flowchart of System and Method for Modular Communication that shows “speech-to-text” and translation capability in the message module in a peer to peer communication in browser-to-mobile (vice versa) or mobile-to-mobile applications method according to the present invention.

FIG. 14 is the flowchart of System and Method for Modular Communication that shows “speech-to-text” and translation capability in the message module with no video module in a peer to peer communication in browser-to-mobile (vice versa) or mobile-to-mobile applications method according to the present invention.

FIG. 15 is the flowchart of System and Method for Modular Communication that shows “speech-to-text”, translation capability, and recipient interaction with message module in the message module in a peer to peer communication in browser-to-mobile (vice versa) or mobile-to-mobile applications method according to the present invention.

FIG. 16 is the flowchart of System and Method for Modular Communication that shows “speech-to-text”, translation capability, and recipient interaction with message module with no video module in the message module in a peer to peer communication in browser-to-mobile (vice versa) or mobile-to-mobile applications method according to the present invention.

FIG. 17 is the flowchart of System and Method for Modular Communication that shows “speech-to-text”, translation capability, and recipient interaction with message module with no video module in the message module in a peer to peer communication in browser-to-mobile (vice versa) or mobile-to-mobile applications method according to the present invention.

FIG. 18 is the flowchart of System and Method for Modular Communication that shows subscription registration to service in a peer to peer communication in browser-to-mobile (vice versa) or mobile-to-mobile applications method according to the present invention.

FIG. 19 is the flowchart of System and Method for Modular Communication that shows subscription registration to service in a peer to peer communication in browser-to-mobile (vice versa) or mobile-to-mobile applications method according to the present invention.

FIG. 20 is the flowchart of System and Method for Modular Communication that shows subscription access to GPS module in a peer to peer communication in browser-to-mobile (vice versa) or mobile-to-mobile applications method according to the present invention.

FIG. 21 is the flowchart of System and Method for Modular Communication that shows subscription access to IPS module in a peer to peer communication in browser-to- mobile (vice versa) or mobile-to-mobile applications method according to the present invention.

FIG. 22 is the flowchart of System and Method for Modular Communication that shows subscription access to movie & clip module in a peer to peer communication in browser-to-mobile (vice versa) or mobile-to-mobile applications method according to the present invention.

FIG. 23 is the flowchart of System and Method for Modular Communication that shows subscription access music module in a peer to peer communication in browser-to- mobile (vice versa) or mobile-to-mobile applications method according to the present invention.

FIG. 24 is the flowchart of System and Method for Modular Communication that shows subscription access to drawing module in a peer to peer communication in browser- to-mobile (vice versa) or mobile-to-mobile applications method according to the present invention.

FIG. 25 is the flowchart of System and Method for Modular Communication that shows subscription ability to customize the modules in a peer to peer communication in browser-to-mobile (vice versa) or mobile-to-mobile applications method according to the present invention.

FIG. 26 is the flowchart of System and Method for Modular Communication that shows subscription access to game module in a peer to peer communication in browser-to- mobile (vice versa) or mobile-to-mobile applications method according to the present invention.

FIG. 27 is the architecture of System and Method for Modular Communication that consists of DB (database), server, and peer to peer connection with data channel.

FIG. 28 is the architecture of System and Method for Modular Communication that consists of database, server, relay server, peer to peer connection with data channel.

FIG. 29 is the modular layout of System and Method for Modular Communication that consists of various modules that holds different independent purposes such as video module, message module, file share module, GPS module, etc.

FIG. 30 is the solution flowchart of System and Method for Modular Communication that shows the steps for user1 to connect with user2. User1 logon url and inputs user2's ID to connect with that user2. User1 clicks “call” and the service prompts for user1 to turn on device camera and microphone.

FIG. 31 is the data flowchart of System and Method for Modular Communication that shows the flow of data during the communication connection.

FIG. 32 illustrates the display screen of the modules on 1 page in a peer to peer communication in browser-to-mobile (vice versa) or mobile-to-mobile applications method of the System and Method for Modular Communication.

FIG. 33 is the block diagram of the System and Method for Modular Communication in a peer to peer communication in browser-to-mobile (vice versa) or mobile-to-mobile applications method according to the present invention.

FIG. 34 is the flowchart of System and Method for Modular Communication that shows module authentication in a peer to peer communication in browser-to-mobile (vice versa) or mobile-to-mobile applications method according to the present invention.

FIG. 35 is the flowchart of System and Method for Modular Communication that shows service analysis of usage in a peer to peer communication in browser-to-mobile (vice versa) or mobile-to-mobile applications method according to the present invention.

FIG. 36 is the flowchart of System and Method for Modular Communication that shows trust between modules in a peer to peer communication in browser-to-mobile (vice versa) or mobile-to-mobile applications method according to the present invention.

FIG. 37 is the flowchart of System and Method for Modular Communication that shows the module display fit and adjustment capability on 1-page screen view in a peer to peer communication in browser-to-mobile (vice versa) or mobile-to-mobile applications method according to the present invention.

FIG. 38 is the flowchart of System and Method for Modular Communication that shows content window in a module in a peer to peer communication in browser-to-mobile (vice versa) or mobile-to-mobile applications method according to the present invention.

FIG. 39 is the flowchart of System and Method for Modular Communication that shows module view adjustment in a peer to peer communication in browser-to-mobile (vice versa) or mobile-to-mobile applications method according to the present invention.

FIG. 40 is the flowchart of System and Method for Modular Communication that shows module sharing authentication in a peer to peer communication in browser-to-mobile (vice versa) or mobile-to-mobile applications method according to the present invention.

FIG. 41 is the flowchart of System and Method for Modular Communication that shows module sharing authentication and subscription in a peer to peer communication in browser-to-mobile (vice versa) or mobile-to-mobile applications method according to the present invention.

FIG. 42 is the flowchart of System and Method for Modular Communication that shows module synchronization capability in a peer to peer communication in browser-to- mobile (vice versa) or mobile-to-mobile applications method according to the present invention.

FIG. 43 is the data flow diagram of System and Method for Modular Communication that shows data flowing in the service in a peer to peer communication in browser-to-mobile (vice versa) or mobile-to-mobile applications method according to the present invention.

FIG. 44 is the block diagram of a module for a system for modular communication comprising a display unit, an input unit, a processing unit, a transmission unit and a receiving unit according to the present invention.

FIG. 45 is the block diagram of a system for modular communication that includes a combination of predetermined unit modules.

FIG. 46 is the block diagram of a system for modular communication that includes a module comprising a speech-to-text module, a translation module and a text-to-speech module.

FIG. 47 is the block diagram of a system for modular communication that includes a share module and a verification module.

### DETAILED DESCRIPTION OF EMBODIMENTS

Contents of the description below merely exemplify the principle of the invention. Therefore those of ordinary skill in the art may implement the theory of the invention and invent various apparatuses which are included within the concept and the scope of the invention even though it is not clearly explained or illustrated in the description. Furthermore, in principle all the conditional terms and embodiments listed in this description are clearly intended for the purpose of understanding the concept of the invention, and one should understand that this invention is not limited to such specially listed exemplary embodiments and the conditions.

The above described objectives, features, and advantages will be more apparent through the following detailed description related to the accompanying drawings, and thus those of ordinary skill in the art may easily implement the technical spirit of the invention.

A detailed description of a publicly known prior art related to the present invention will be omitted if determined that it may unnecessarily obscure the gist of the present invention. Hereinafter, it will be described in detail with reference to the accompanying drawings.

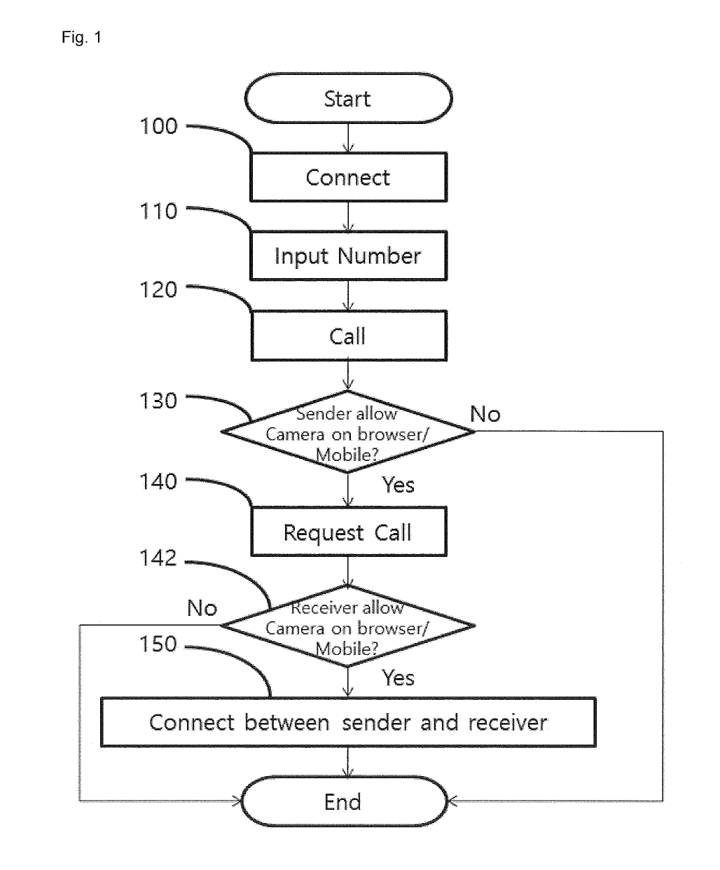

FIG. 1 is the flowchart of System and Method for Modular Communication that shows the user connects with another user in a peer to peer communication in browser-to-mobile (vice versa) or mobile-to-mobile applications method. User logs onto service to connect 100.

User inputs a call number 110 to locate another user to connect. User makes the call 120 and the service asks to turn on user device's camera and microphone 130, in order for the user to connect to another user. If user declines to turn on camera and microphone, then service ends and user is not connected with another user. If user turns on camera and microphone, then user is connected to server and send connection requests to the other user. The receiver user gets request call and asks to turn on camera and microphone 142 on browser or mobile application. If receiver declines request call, then connection ends and both users are not connected. If receiver accepts request call, then connect is established 150. The users connected and see each other on video screen on service.

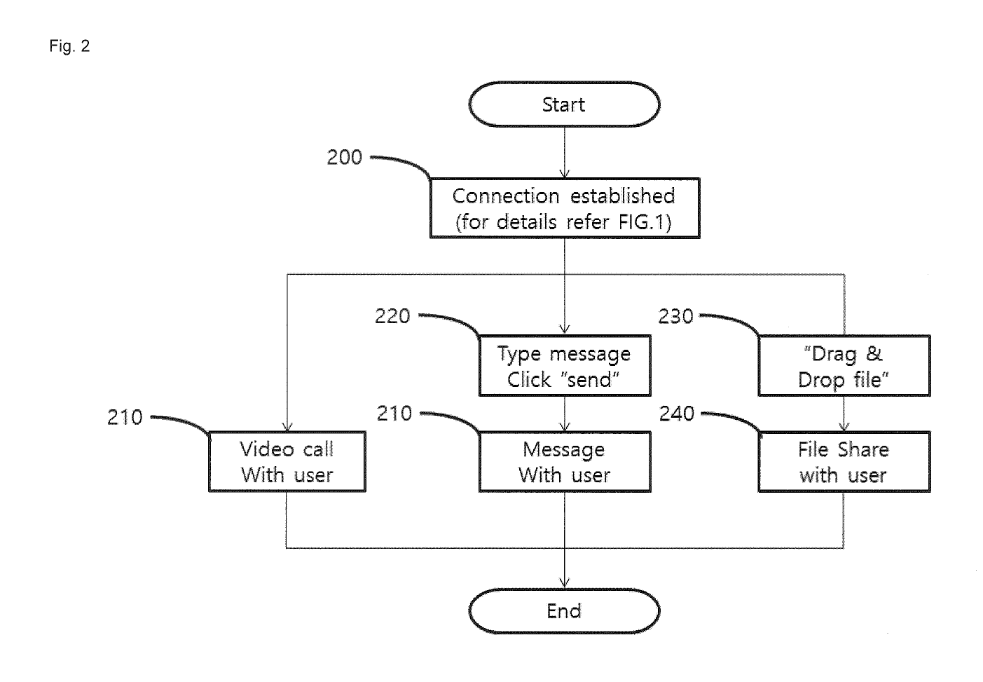

FIG. 2 is the flowchart of System and Method for Modular Communication that shows when user communicates with another user using video module, message module, and file share module in a peer to peer communication in browser-to-mobile (vice versa) or mobile-to-mobile applications method. The user establishes peer to peer connection 200. Once connected, user can video call module 210 and view himself/herself and the other user in the user's video module on the service. When using the message module with another user 210, user needs to click “send” button in message module to send the message to another user 220. Users can also share files with each other 240 in file share module by dragging files from user's source onto the service 230, where it is instantly sent as message in the sender user's message module to the other user's message module.

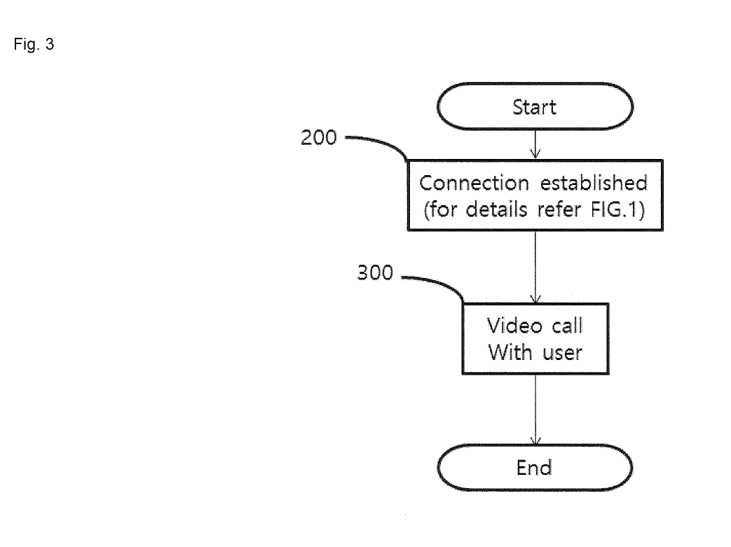

FIG. 3 is the flowchart of System and Method for Modular Communication that shows uses video module only in a peer to peer communication in browser-to-mobile (vice versa) or mobile to-mobile applications method. The user establishes peer to peer connection 200. This figure shows when user only does video call with another user 300 in the video module and does not use message module or file sharing module offered by the service. The users can hear and view each other in each user's respective video modules. Once the communication is finished, the users can end the video call and connection between the two will disconnect.

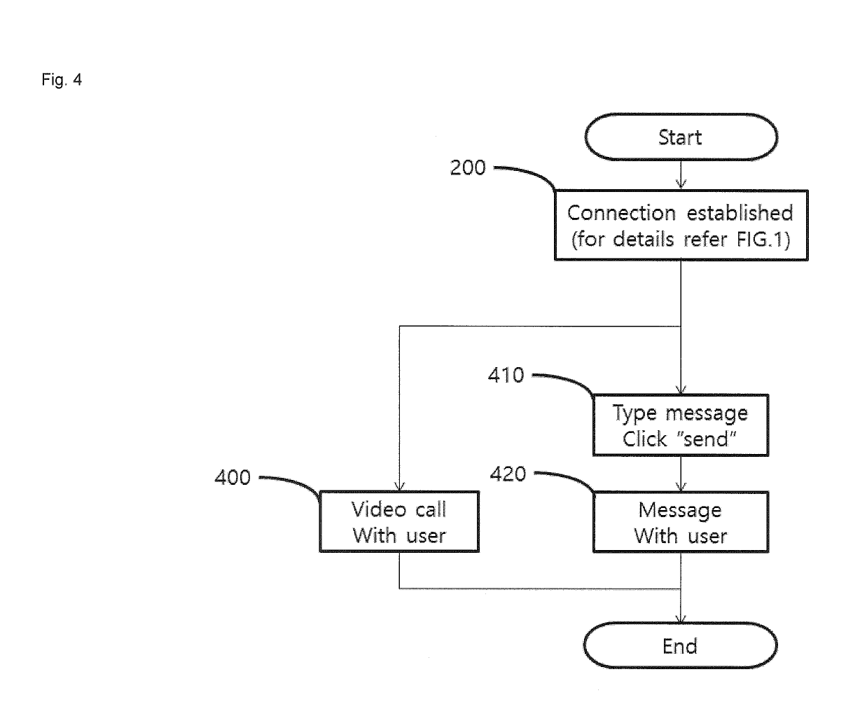

FIG. 4 is the flowchart of System and Method for Modular Communication that shows video call module and message module in use in a peer to peer communication in browser-to-mobile (vice versa) or mobile-to-mobile applications method. First shows when user establishes peer to peer connection 200. Once connected, user can use video module 400 and view himself/herself and the other user in the user's video module on the service. The users can hear and view each other in each user's respective video modules. When using the message module with another user 420, user needs to click “send” button in message module to send the message to another user 410.

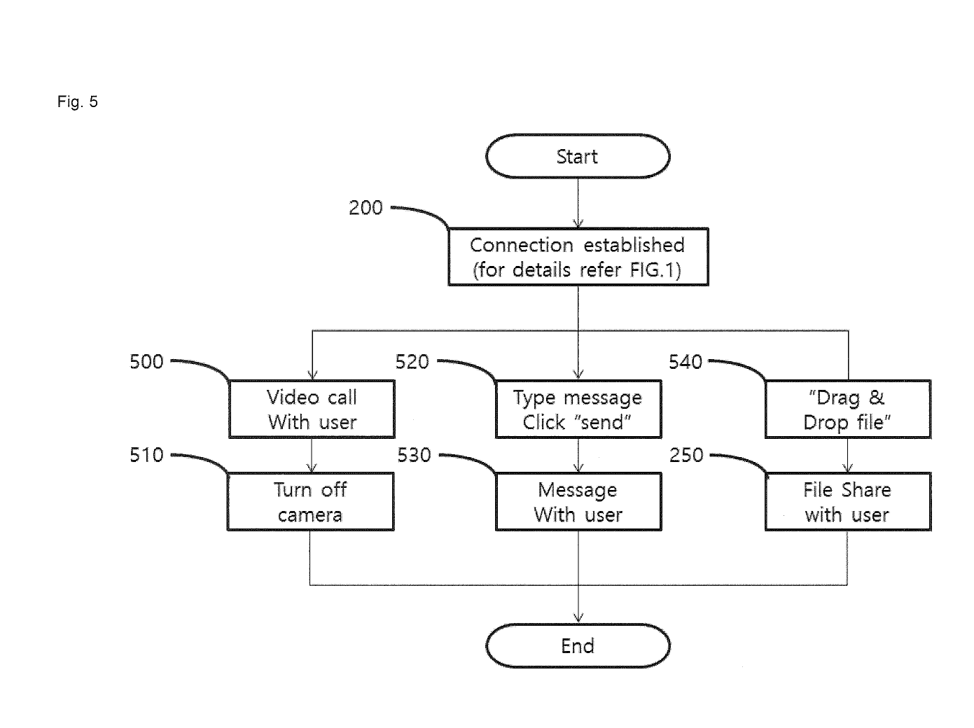

FIG. 5 is the flowchart of System and Method for Modular Communication that shows video call module with ability to turn off camera, message module, and file share module in use in a peer to peer communication in browser-to-mobile (vice versa) or mobile-to-mobile applications method. This shows when user establishes peer to peer connection 200. This shows when the user connects with video call 500, but can choose to turn off camera 510 in video module while in connection with another user. This means the other user will NOT be able to view or hear from the user who turned off the camera from his/her video module. The user will still be able to communicate with the other user through message module 520, 530. The user will still be able use file share module with the other user by dragging and dropping the files from user's source 540, 550 and share the files to the other user. The file message is inserted into the message module from the sender user and shows to both users’ message module.

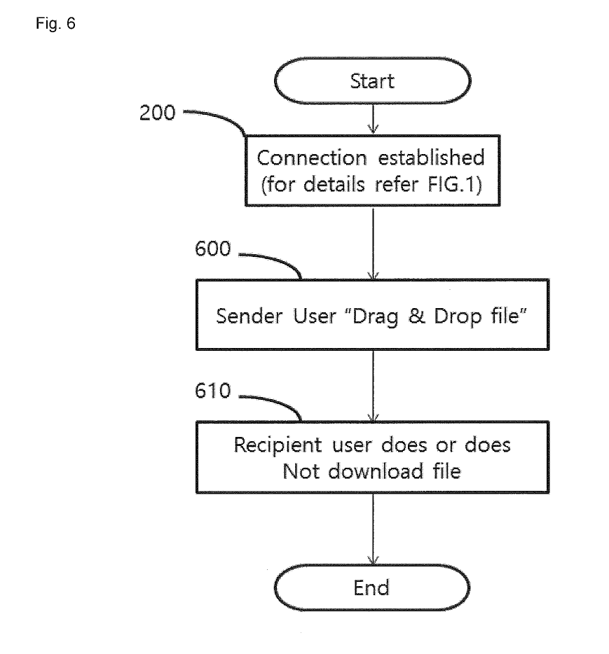

FIG. 6 is the flowchart of System and Method for Modular Communication that shows only file share module in use in a peer to peer communication in browser-to-mobile (vice versa) or mobile-to-mobile applications method. First shows when user establishes peer to peer connection 200. Referring to Fig.6, user connects with another user with only file share module, without video module or message module. The user drag files from user's source and drop into the file share module 600. The file is inserted into the sender user's message module and waits for the recipient user to either download or not download the file from the recipient user's message. The users will NOT see or hear from each other.

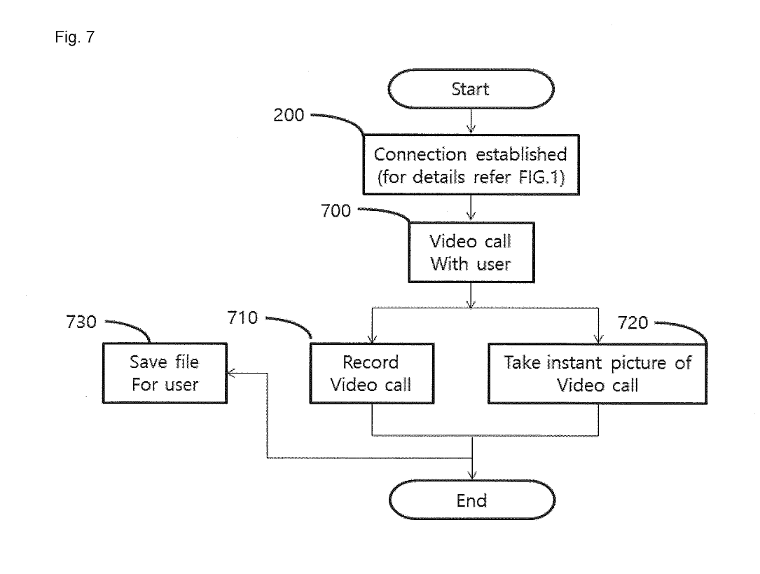

FIG. 7 is the flowchart of System and Method for Modular Communication that shows file share module interaction capabilities in a peer to peer communication in browser-to-mobile (vice versa) or mobile-to-mobile applications method. First shows when user establishes peer to peer connection 200. During the video call connection 700 in video module, the user can record the video call 710, which would capture the dialog and video of both users. The users can hear and view each other in each user's respective video modules. The user responsible for clicking record in video module during the video call would have the file saved in the user's designated folder 730. During the video call, the user can take instant picture of the video call 720, as a snapshot in the video module. This snapshot would be saved in the designated folder for the user responsible for taking the picture 730.

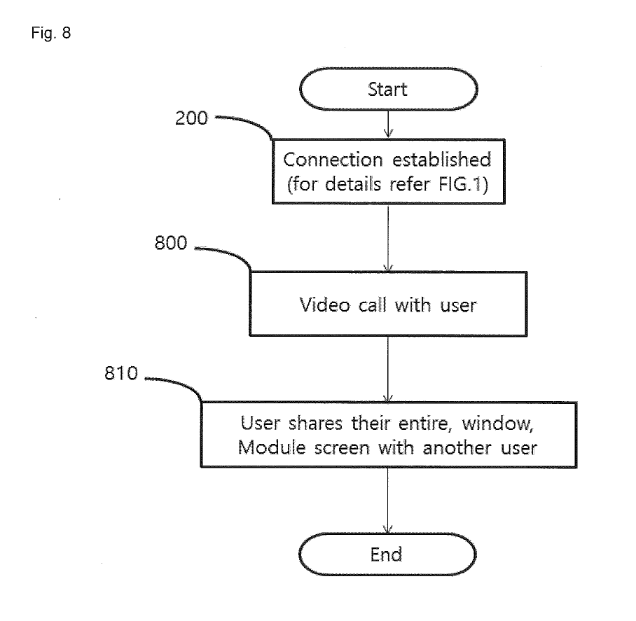

FIG. 8 is the flowchart of System and Method for Modular Communication that shows screen share capabilities in the file share module in a peer to peer communication in browser-to-mobile (vice versa) or mobile-to-mobile applications method. First shows when user establishes peer to peer connection 200. This shows video call in video module in use 800. The users can hear and view each other in each user's respective video modules. During the video call, user can 810 shares his/her entire screen, the select window screen, or module screen with another user.

For module sharing, the recipient would require having the same module as the module that the sender user is attempting to share.

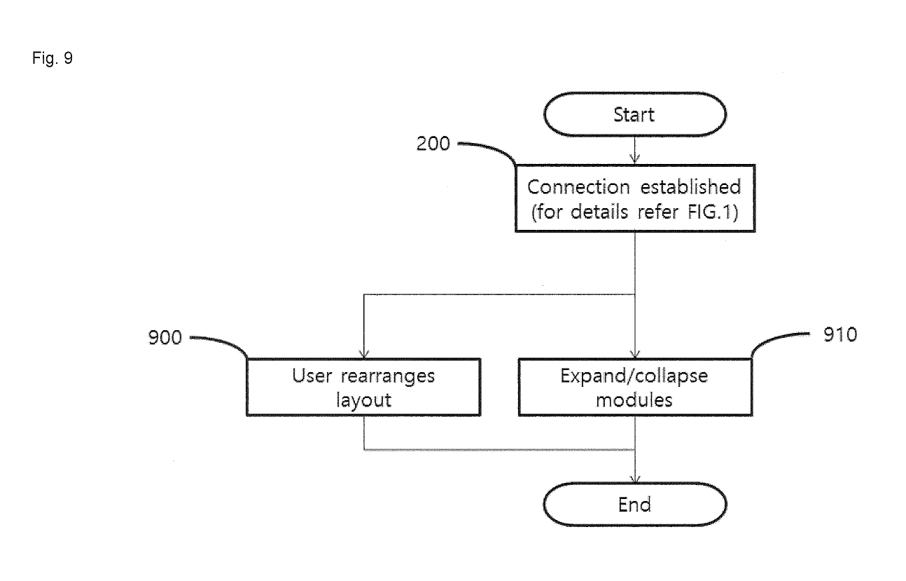

FIG. 9 is the flowchart of System and Method for Modular Communication that shows module layout interaction in all modules in a peer to peer communication in browser-to-mobile (vice versa) or mobile-to-mobile applications method. First shows when user establishes peer to peer connection 200. The user can rearrange the layout of the modules 900 by swapping places of the modules on the service. The user can expand or collapse certain modules on the service 910. This interaction has no relation with another user and only applies to the individual user.

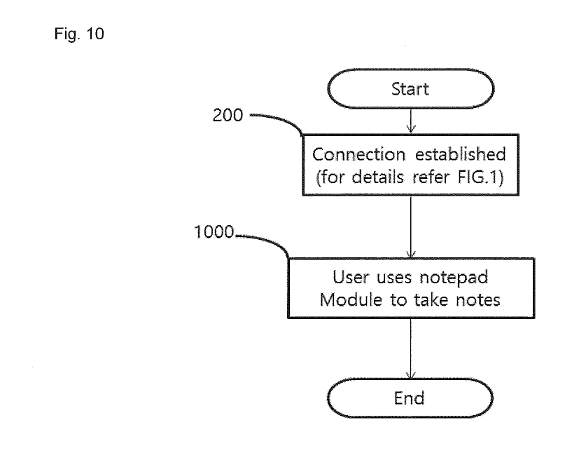

FIG. 10 is the flowchart of System and Method for Modular Communication that shows notepad module in a peer to peer communication in browser-to-mobile (vice versa) or mobile-to-mobile applications method. First shows when user establishes peer to peer connection 200. The user can use notepad module to take notes during the communication. This interaction has no relation with another user and only applies to the individual user until the user decides to share the notepad module with another user.

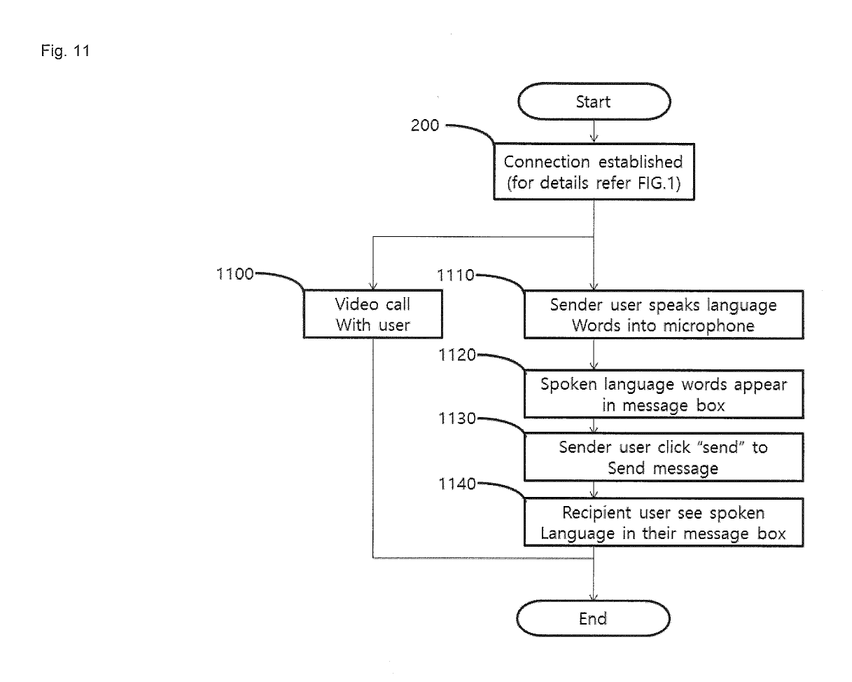

FIG. 11 is the flowchart of System and Method for Modular Communication that shows “speech-to-text” capability in the message module in a peer to peer communication in browser-to-mobile (vice versa) or mobile-to-mobile applications method. First shows when user establishes peer to peer connection 200. The user does video call in the video module 1100 with another user. The users can hear and view each other on each other's respective video modules. Sender user use “speech to text” function that will insert spoken language words from microphone into message module 1110, 1120. User required to click “send” button to send message on message module 1130. Recipient user will receive the spoken language words in their message module 1140.

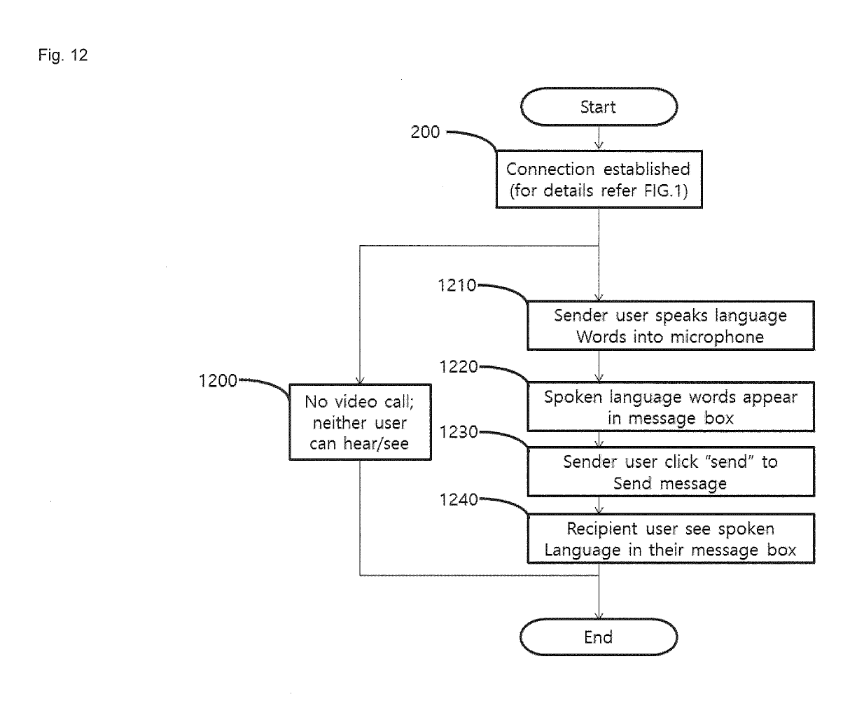

FIG. 12 is the flowchart of System and Method for Modular Communication that shows “speech-to-text” capability in the message module with no video module in a peer to peer communication in browser-to-mobile (vice versa) or mobile-to-mobile applications method. First shows when user establishes peer to peer connection 200. The user does NOT have video call in the video module 1200 with another user. The users cannot hear and view each other on each other's respective video modules. Sender user use “speech to text” function that will insert spoken language words from microphone into message module 1210, 1220. User required to click “send” button to send message on message module 1230. Recipient user will receive the spoken language words in their message module 1240.

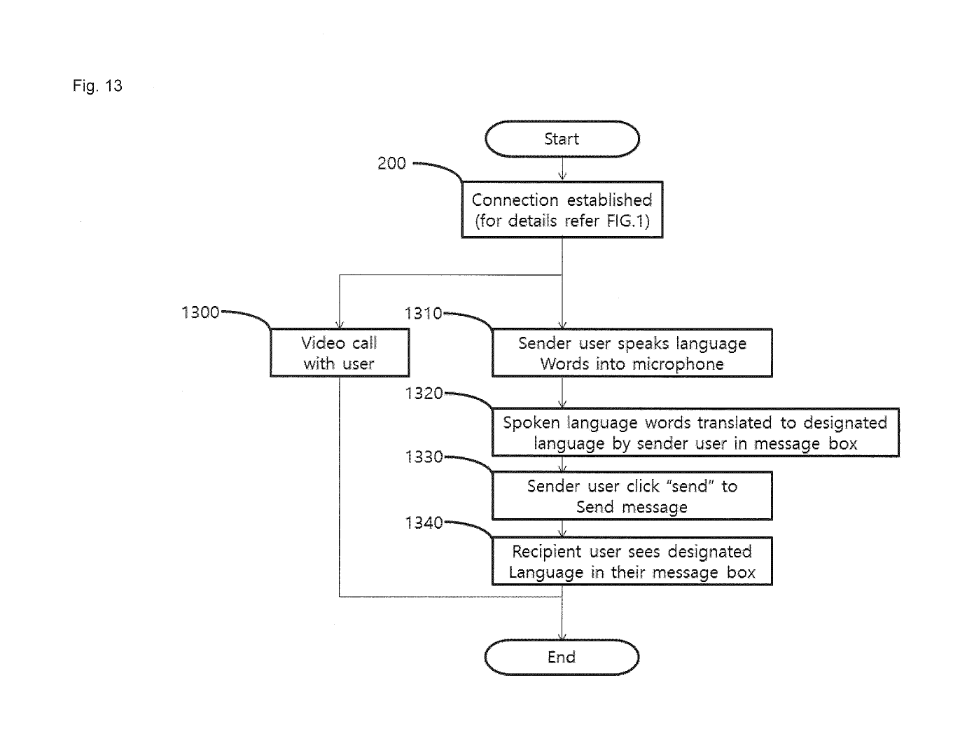

FIG. 13 is the flowchart of System and Method for Modular Communication that shows “speech-to-text” and translation capability in the message module in a peer to peer communication in browser-to-mobile (vice versa) or mobile-to-mobile applications method. First shows when user establishes peer to peer connection 200. The user does video call in the video module 1300 with another user. The users can hear and view each other on each other's respective video modules. Sender use “speech to text” and translation function that will translate the spoken language words from microphone to the designated translation language words in message module 1310, 1320. User required to click “send” button to send message on message module 1330. Recipient user will receive the designated translated words in their message module 1340.

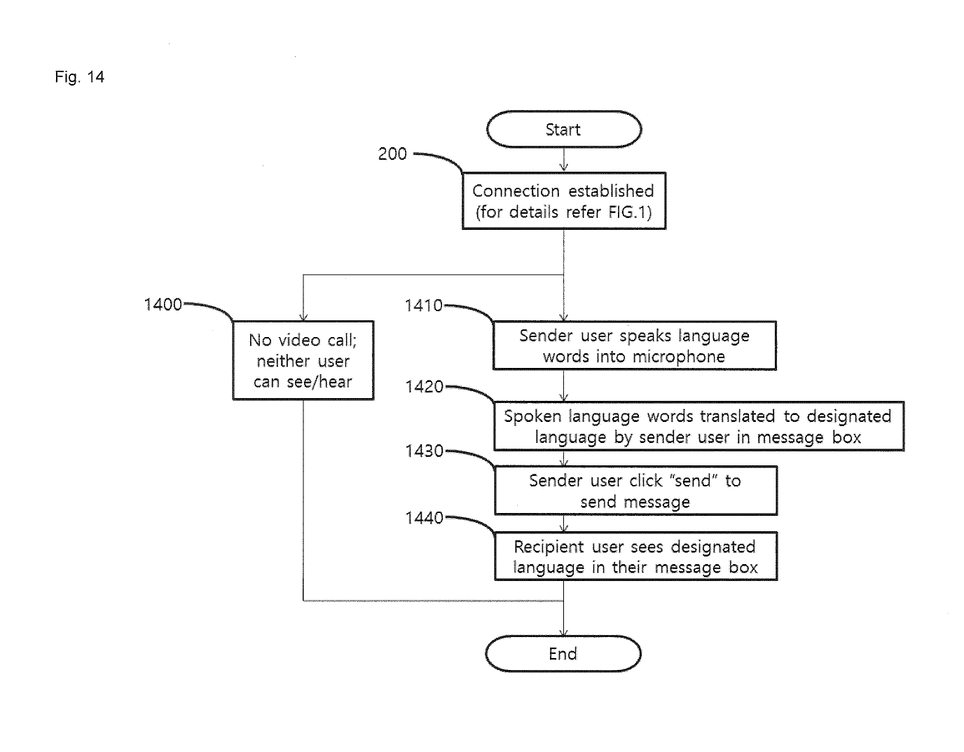

FIG. 14 is the flowchart of System and Method for Modular Communication that shows “speech-to-text” and translation capability in the message module with no video module in a peer to peer communication in browser-to-mobile (vice versa) or mobile-to- mobile applications method. First shows when user establishes peer to peer connection 200. The user does NOT have video call in the video module 1200 with another user. The users cannot hear and view each other on each other's respective video modules. Sender use “speech to text” and translation function that will translate the spoken language words from microphone to the designated translation language words in message module 1410, 1420. User required to click “send” button to send message on message module 1430. Recipient user will receive the designated translated words in their message module 1440.

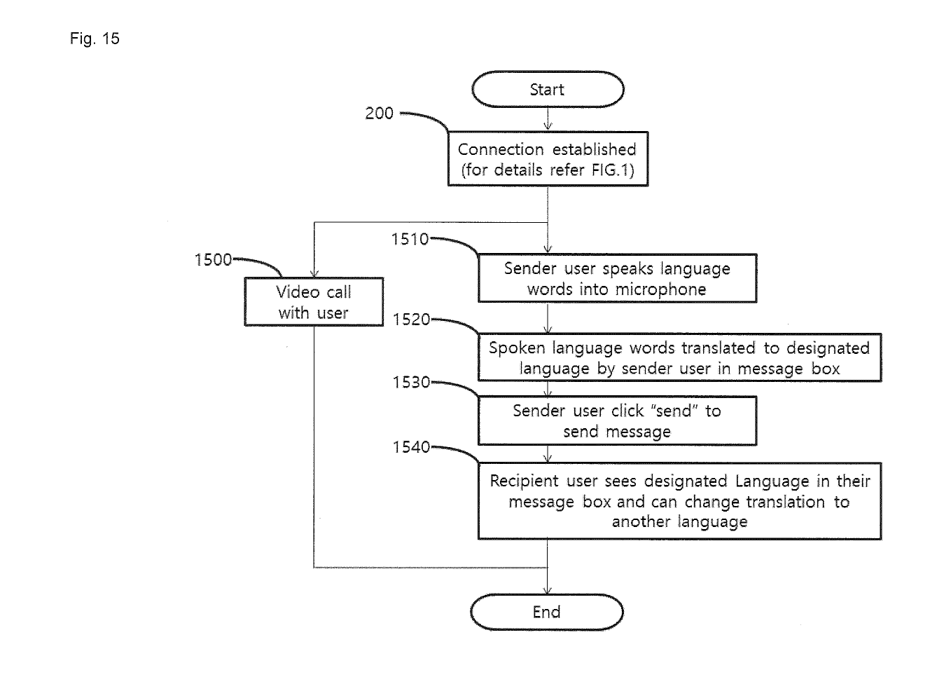

FIG. 15 is the flowchart of System and Method for Modular Communication that shows “speech-to-text”, translation capability, and recipient interaction with message module in the message module in a peer to peer communication in browser-to-mobile (vice versa) or mobile-to-mobile applications method. First shows when user establishes peer to peer connection 200. The user does video call in the video module 1500 with another user. The users can hear and view each other on each other's respective video modules. Sender use “speech to text” and translation function that will translate the spoken language words from microphone to the designated translation language words in message module 1410, 1420. User required to click “send” button to send message on message module 1430. Recipient user will receive the designated translated words in their message module 1340. Recipient user will see the designated translation language words in their message box, but can change the translation for another language 1540.

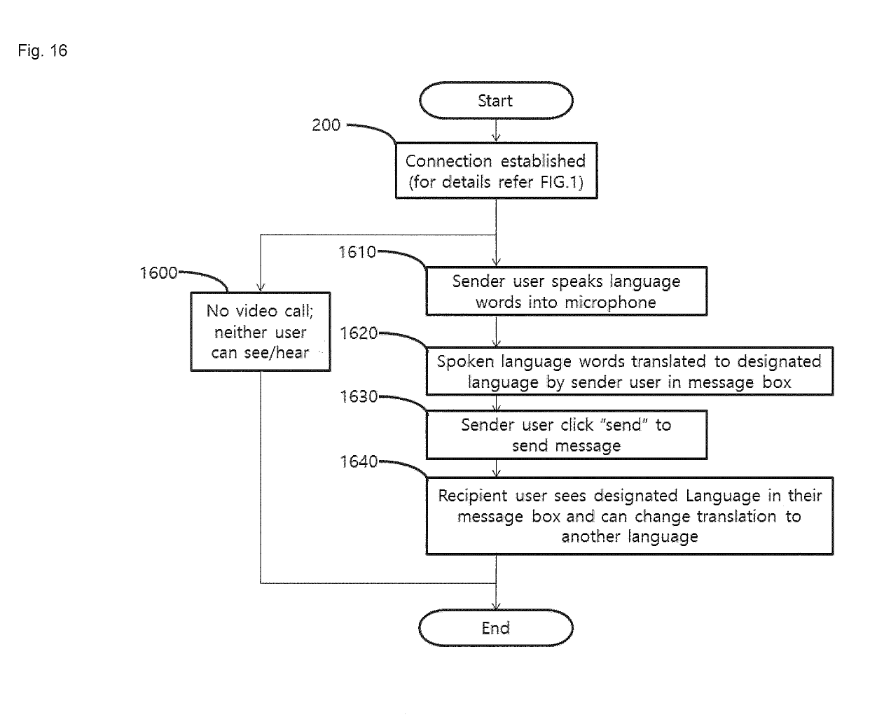

FIG. 16 is the flowchart of System and Method for Modular Communication that shows “speech-to-text”, translation capability, and recipient interaction with message module with no video module in the message module in a peer to peer communication in browser-to- mobile (vice versa) or mobile-to-mobile applications method. First shows when user establishes peer to peer connection 200. The user does NOT have video call in the video module 1600 with another user. The users cannot hear and view each other on each other's respective video modules.

Sender use “speech to text” and translation function that will translate the spoken language words from microphone to the designated translation language words in message module 1610, 1620. User required to click “send” button to send message on message module 1630. Recipient user will receive the designated translated words in their message module 1640. Recipient user will see the designated translation language words in their message box, but can change the translation for another language 1640.

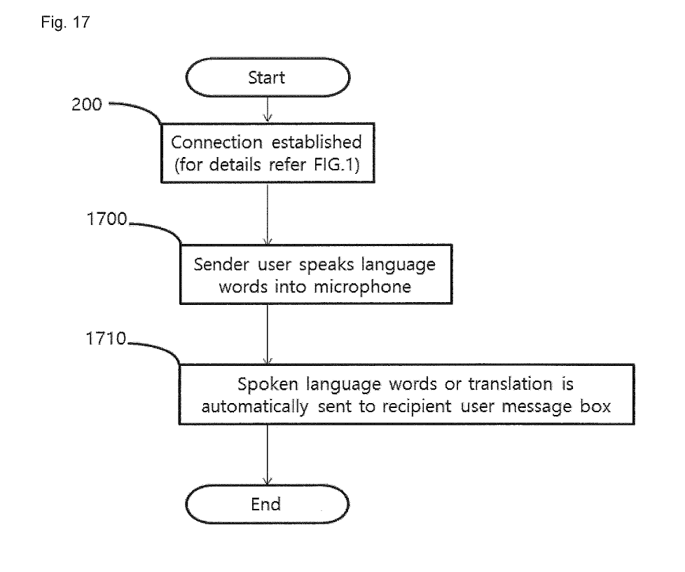

FIG. 17 is the flowchart of System and Method for Modular Communication that shows “speech-to-text”, translation capability, and recipient interaction with message module with no video module in the message module in a peer to peer communication in browser-to- mobile (vice versa) or mobile-to-mobile applications method. First shows when user establishes peer to peer connection 200. Sender user speaks language words from microphone and inserted into message module 1700. The spoken language words or translation is automatically sent to recipient user message module 1710. Regarding FIG. 13 to FIG. 17, it is necessary to recognize the language of the speech input by users in order to translate it. According to the exemplary embodiment, it is possible to detect the language through the user's setting or by an internal algorithm.

First, the language spoken into the module may either be input by the user through the settings, or in the absence of such setting automatically use the default language value used by the system.

Alternatively, the module can automatically detect the language through an algorithm by comparing the first spoken sentence against a database. The module can utilize additional system environment information to reduce the number of comparisons to the database.

For example, the very first word spoken by the user may be a greeting, so the algorithm can compare that to a database of greetings of the world to detect the language. Furthermore, the algorithm can take into account the time of day to compare against a more appropriate set of greetings to identify the language more effectively.

Additionally, the user's geo-location may be referenced, in which the algorithm will compare the language of the user's presiding country against its database with priority.

At this point, the language subject to translation can be automatically recognized and translated as the above described examples in accordance with the user setting information or the internal algorithm of the receiver side.

Additionally, the receiving user may re-translate on their end as follows in FIG. 15 and FIG. 16.

Furthermore, concerning the sending of input speech as detailed in FIG. 17, where FIG. 13 to FIG. 16 transmitted upon clicking the ‘send’ button, users can also have their message sent automatically 1710.

In order to transmit messages automatically, it is necessary to set a pause threshold in which the message will send after a predetermined length of silence, or for the algorithm to detect the end in speech through intonation. Alternatively, the speech can be compared to the limit of a text message, at which point it will send automatically.

In such a scenario, the module can detect the completion of the speech grammatically before automatically transmitting, in order to prevent the fracturing of the message.

Additionally, concerning the text limit of messages, because different languages may express the same meaning in varying lengths, it is possible to adjust the text threshold depending on the language. If the sender's and receiver's languages differ, this shall be reflected in their differing text limit thresholds.

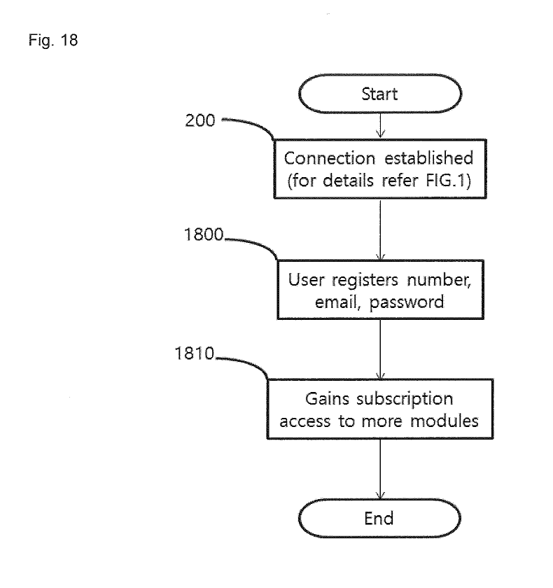

FIG. 18 is the flowchart of System and Method for Modular Communication that shows subscription registration to service in a peer to peer communication in browser-to-mobile (vice versa) or mobile-to-mobile applications method. First shows when user establishes peer to peer connection 200. User subscribes to service by registering a number with email and password 1800. The user gains subscription access to more modules to current existing modules from free service 1810.

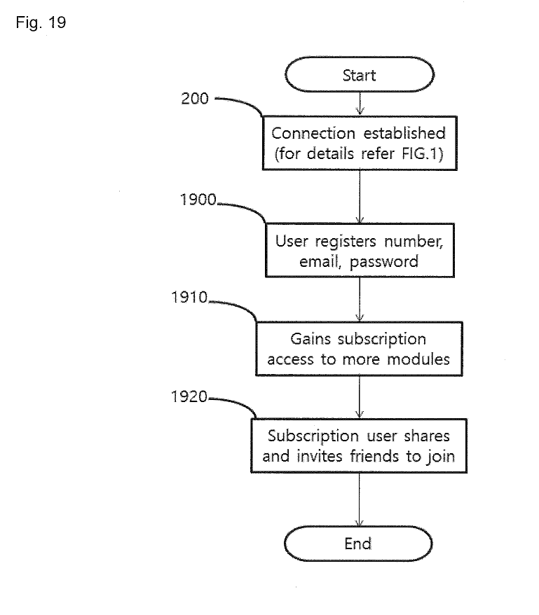

FIG. 19 is the flowchart of System and Method for Modular Communication that shows subscription registration to service in a peer to peer communication in browser-to-mobile (vice versa) or mobile-to-mobile applications method. First shows when user establishes peer to peer connection 200. User subscribes to service by registering a number with email and password 1900. The user gains subscription access to more modules to current existing modules from free service 1910. The user shares and invites friends to join using social media module 1920.

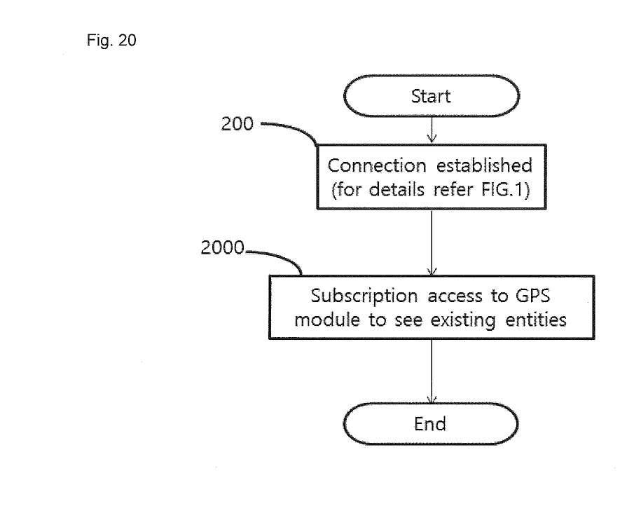

FIG. 20 is the flowchart of System and Method for Modular Communication that shows subscription access to GPS module in a peer to peer communication in browser-to-mobile (vice versa) or mobile-to-mobile applications method. First shows when user establishes peer to peer connection 200. The GPS module access allow users to see existing entities 2000.

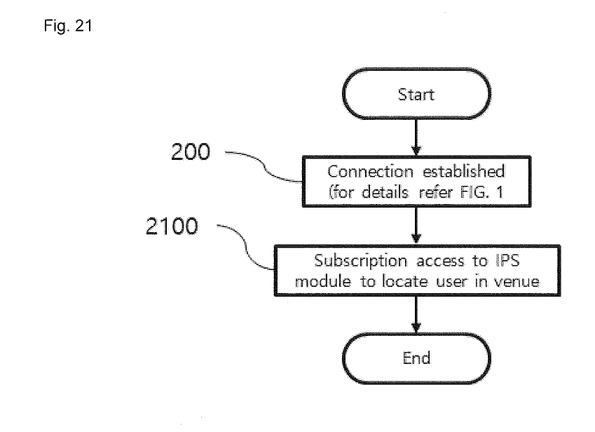

FIG. 21 is the flowchart of System and Method for Modular Communication that shows subscription access to IPS module in a peer to peer communication in browser-to-mobile (vice versa) or mobile-to-mobile applications method. First shows when user establishes peer to peer connection 200. The IPS (in-door positioning service) module access allow users to locate another user in a venue i.e. stores within a mall 2100.

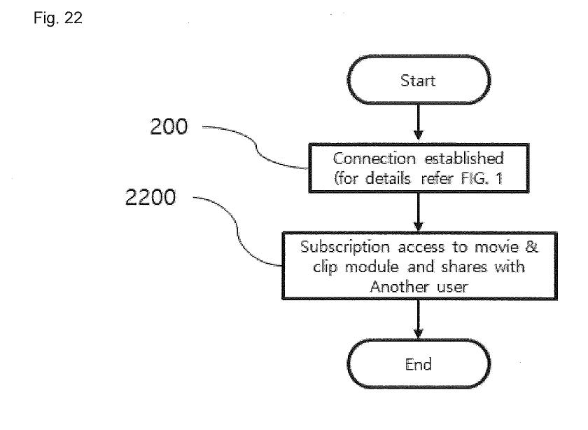

FIG. 22 is the flowchart of System and Method for Modular Communication that shows subscription access to movie & clip module in a peer to peer communication in browser-to-mobile (vice versa) or mobile-to-mobile applications method. First shows when user establishes peer to peer connection 200. The movie & clip module access allow users to create original movies, edit clips, stream content, and share with another user 2200.

At this point, concerning the user's movie and media, it may be necessary to verify the content for authorization.

For example, if the video to be shared requires registration by the providing enterprise, the sharee (the user on the receiving end) will have to connect to their server and register.

In such a scenario, instead of redirecting the sharee to a separate window, it will be possible to bring up the registration page within this module of this embodiment for additional convenience. Furthermore, personal information stored on the user's system can be used to fill out the registration form.

If the sharee does not wish to register, then the sharing process will be discontinued.

Following the above registration process, if all parties are successfully registered then the video will be shared. At this point, the sharer's video is synchronized with the sharee's, so any seeking of the video's duration done by the sharing user will also be reflected on the receiving user's end to foster discussion. Such discussion can take place via speech to text (or vice versa) detailed in FIG. 11 to FIG. 17 as an overlay.

Additionally, the module can provide automated translated captions following the mechanisms described in FIG. 13 to FIG. 17.

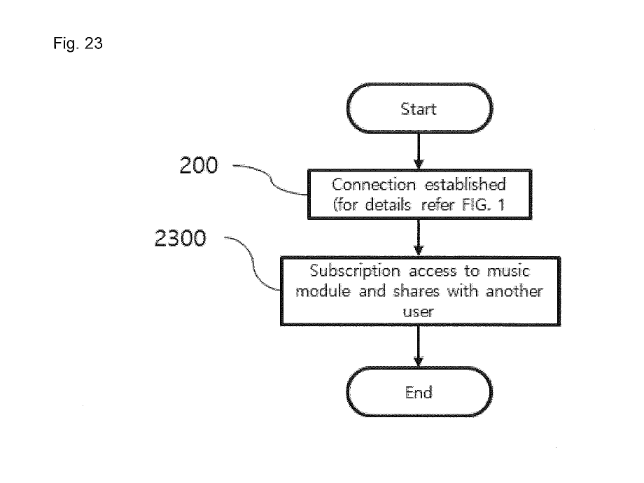

FIG. 23 is the flowchart of System and Method for Modular Communication that shows subscription access music module in a peer to peer communication in browser-to-mobile (vice versa) or mobile-to-mobile applications method. First shows when user establishes peer to peer connection 200. The music module access allow users to listen to music and share with another user 2300. The music module would have subscription service to streaming services and also has capability to create/edit own music.

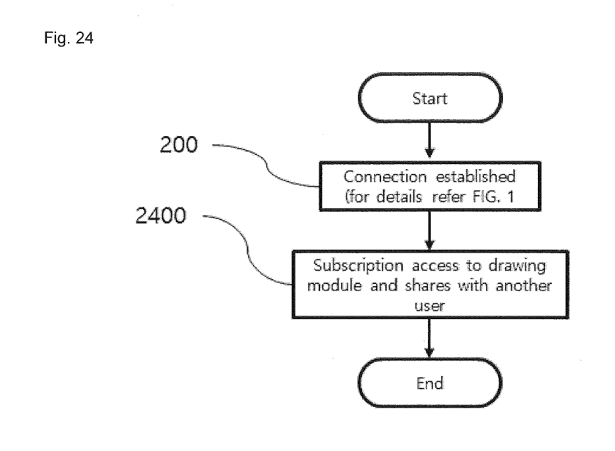

FIG. 24 is the flowchart of System and Method for Modular Communication that shows subscription access to drawing module in a peer to peer communication in browser-to-mobile (vice versa) or mobile-to-mobile applications method. First shows when user establishes peer to peer connection 200. The drawing module access allow users to draw images and share with another user 2400. The drawing module can combine with the drawing module and create a single module that flips upon user selection.

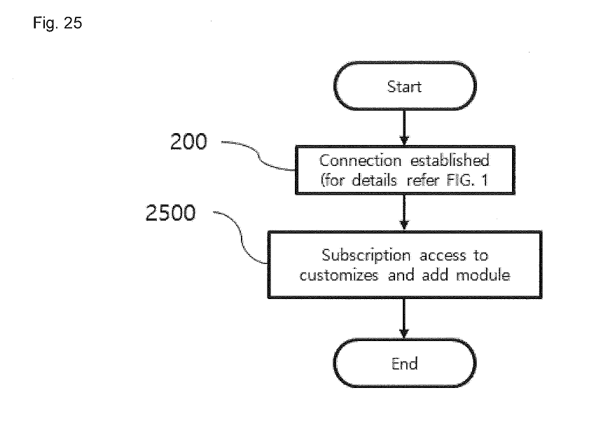

FIG. 25 is the flowchart of System and Method for Modular Communication that shows subscription ability to customize the modules in a peer to peer communication in browser-to-mobile (vice versa) or mobile-to-mobile applications method. First shows when user establishes peer to peer connection 200. The ability to customize and add modules allow users create 3rd party applications 2500.

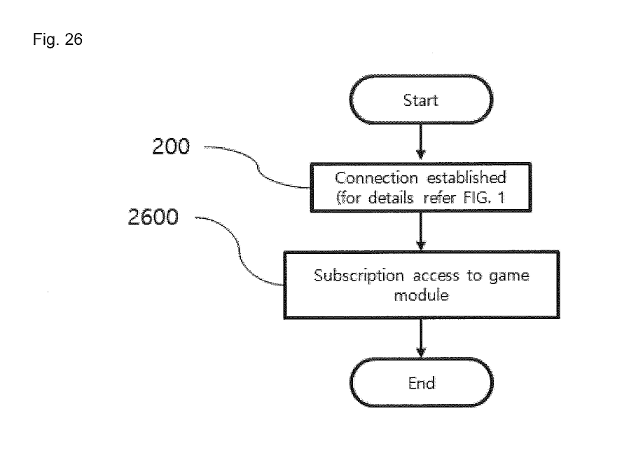

FIG. 26 is the flowchart of System and Method for Modular Communication that shows subscription access to game module in a peer to peer communication in browser-to- mobile (vice versa) or mobile-to-mobile applications method. First shows when user establishes peer to peer connection 200. The game module allow users to play games in the module 2600.

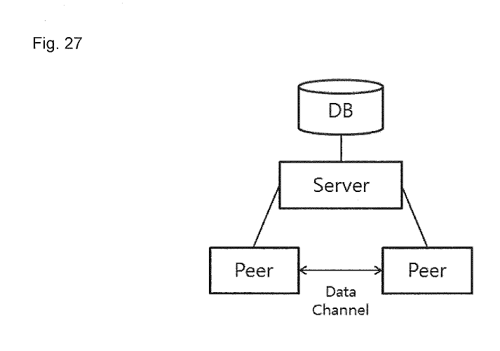

FIG. 27 is the architecture of System and Method for Modular Communication that consists of DB (database), server, and peer to peer connection with data channel.

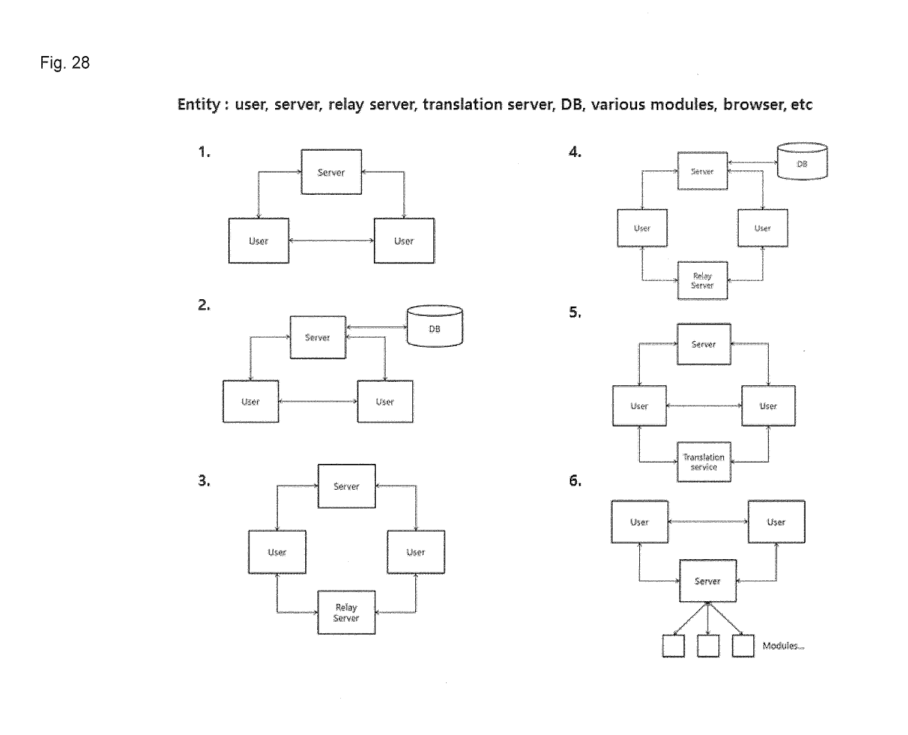

FIG. 28 is the architecture of System and Method for Modular Communication that consists of database, server, relay server, peer to peer connection with data channel. Image 1 shows peer to peer using server. Image 2 shows peer to peer using server connected to database. Image 3 shows peer to peer through relay server and server. Image 4 shows peer to peer through relay server and server connected to database. Image 5 shows peer to peer with translation service and server. Image 6 shows peer to peer through server and modules are connected via server.

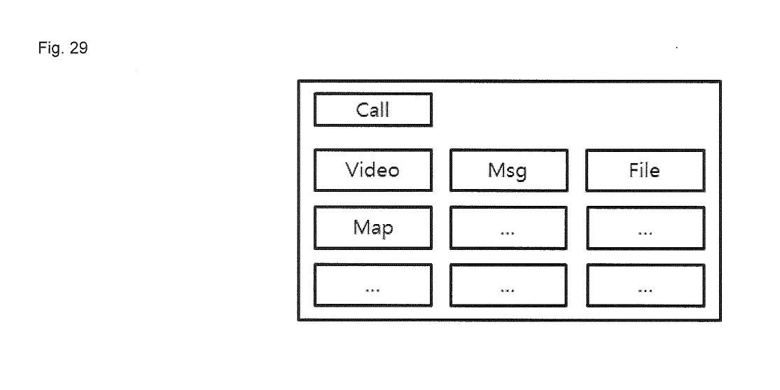

FIG. 29 is the modular layout of System and Method for Modular Communication that consists of various modules that holds different independent purposes such as video module, message module, file share module, GPS module, etc. The call button on the service allows for user to connect with another user on server.

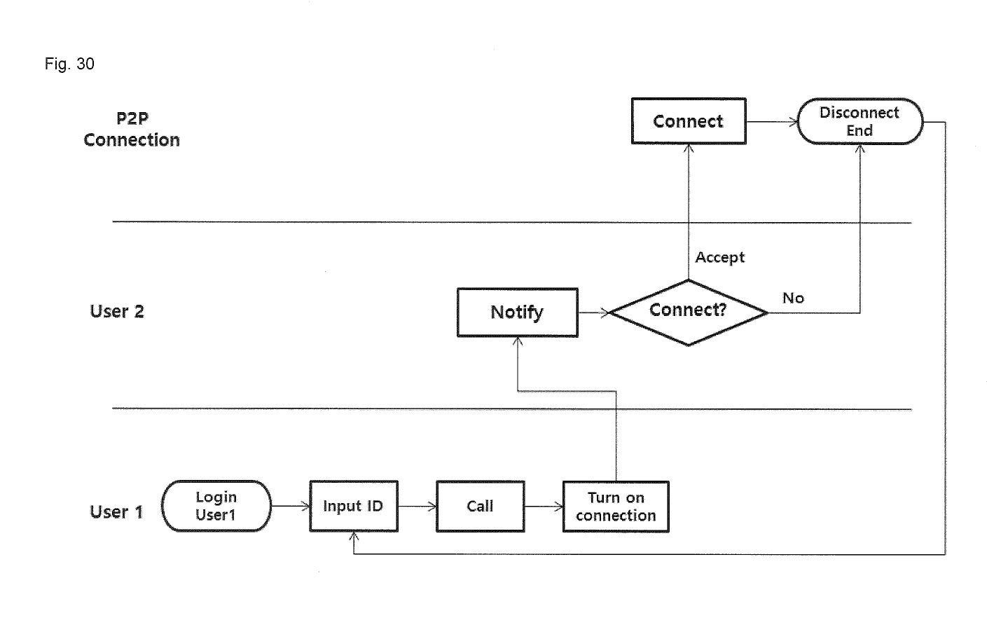

FIG. 30 is the solution flowchart of System and Method for Modular Communication that shows the steps for user1 to connect with user2. User1 logon url and inputs user2's ID to connect with that user2. User1 clicks “call” and the service prompts for user1 to turn on device camera and microphone. Once user1 turns on camera and microphone, the call request notifies user2. The user2 has choice to accept or decline user1's call request. If declines, no connection established and call ends. If user2 accepts user1's call request, the connection between the users are established on a peer to peer communication. Either user can disconnect from the communication at any time.

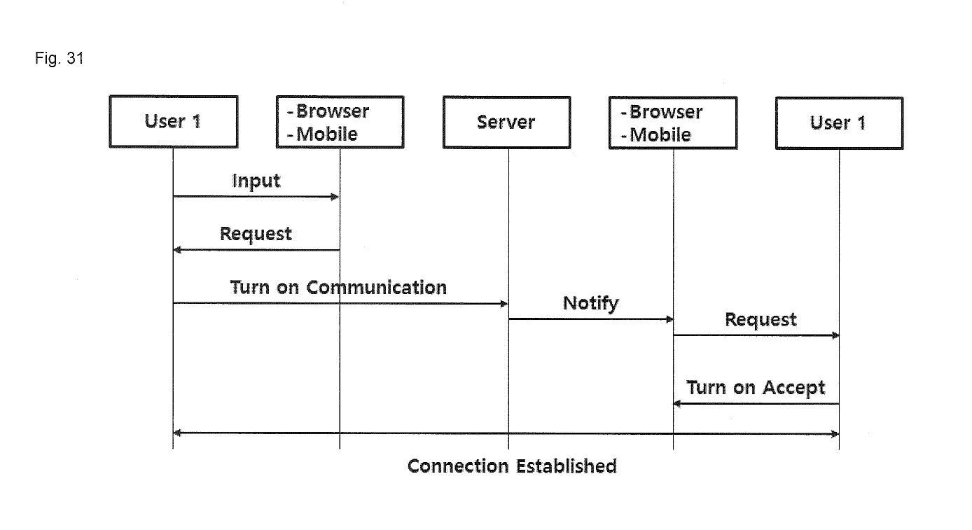

FIG. 31 is the data flowchart of System and Method for Modular Communication that shows the flow of data during the communication connection. User1 sends input to browser or mobile application of the service, which then sends a request back to User1 to turn on camera and microphone on User1's device. User1 agrees and that data is sent to server, which then the server notifies User2's browser or mobile application of the service. The User2's browser or mobile application of the service sends a request to turn on camera and microphone to User2, who then decides to accept or decline the call request from User1. If

User2 accepts, then the connection is established and data flows freely from User1 to User2 and vice versa.

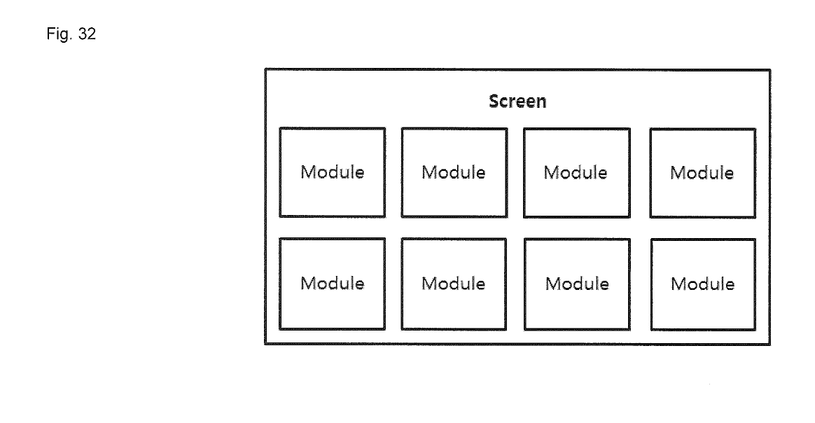

FIG. 32 illustrates the display screen of the modules on 1 page in a peer to peer communication in browser-to-mobile (vice versa) or mobile-to-mobile applications method of the System and Method for Modular Communication. The modular format allows for 1 page interaction for the user with the service. Each module is independent of each other and provides a different aspect of the service for the user. Certain modules will require subscription to access those modules, and certain content will require authentication.

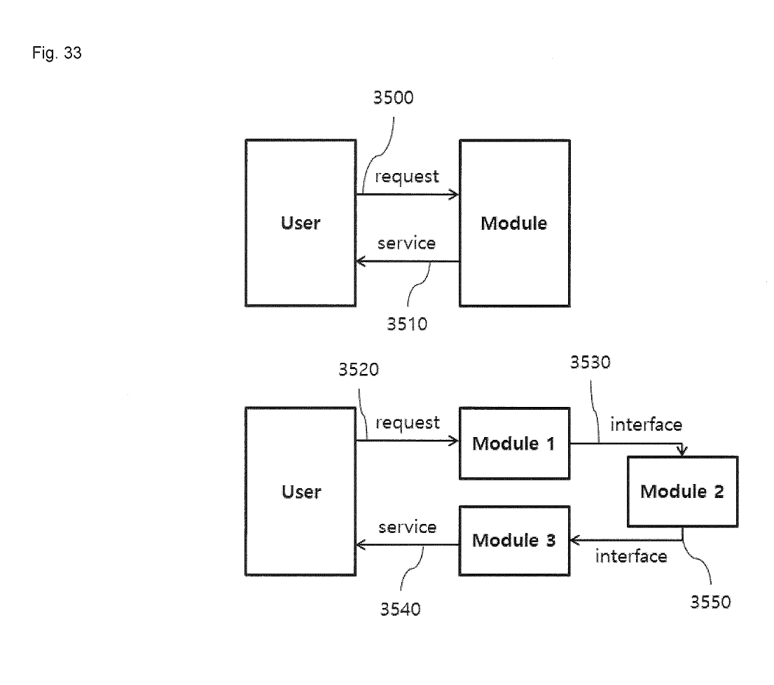

FIG. 33 is the block diagram of the System and Method for Modular Communication in a peer to peer communication in browser-to-mobile (vice versa) or mobile-to-mobile applications method.

User interacts with the module 3500, and by response, the module provides service 3510. User interacts with module1, 3520, i.e. speak into speech-to-text module. The module1 will interface with module2, 3530, i.e. the speech content will go to message module. The module2 will interface with module3, 3550, i.e. the message module will work with API to translate the spoke text to designated language and provide text-to-speech content in module3, 3540, back to user.

In other words, FIG. 33 shows the creation of new functionality (in this case, translation) by the user combining different modules. Thus, in this embodiment, it is possible to connect modules through their interfaces following certain protocols. The first protocol is that of restriction of the head module and the tail module, namely that the input format of the head module must match the output format of the tail module. In other words, if the head module receives a speech input, the tail module must return a speech output, as illustrated in FIG. 33. Thus the interfaces of the connecting modules can be designated.

The second protocol concerns any modules between the head module and tail module, namely that the input and output formats of any middle modules must match the format of its preceding module's output and succeeding module's input, respectively.

FIG. 33 shows how Module 2, as a translation module, receives input as text, which is the format Module 1 outputs, and outputs translated text, which is also the format Module 3 takes as input.

Following protocols 1 and 2, it is possible to interface different modules to create new functionality.

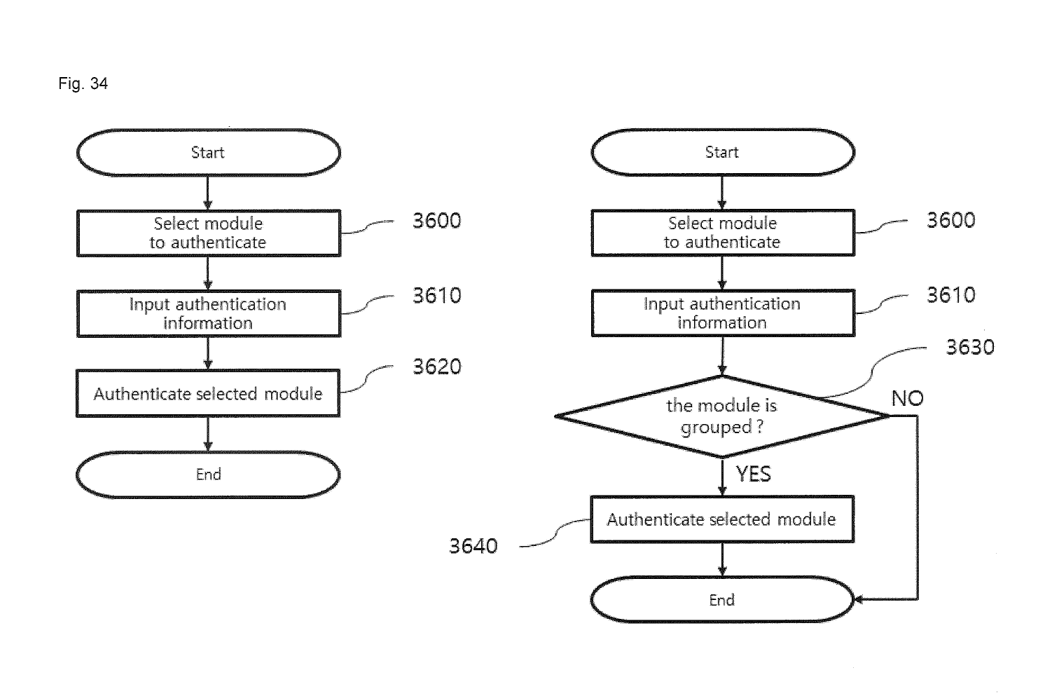

FIG. 34 is the flowchart of System and Method for Modular Communication that shows module authentication in a peer to peer communication in browser-to-mobile (vice versa) or mobile-to-mobile applications method. The user selects module to interact 3600 and input authentication information into module 3610. The module is then authenticated 3620. Another use case is group module authentication. The user selects module to interact 3600 and input authentication information into module 3610. The service will determine if the selected module is part of a group during the authentication 3630. If yes, all other modules in the same group in which the selected module is authenticated, are all authenticated at same time 3640. If no, then no other modules will be authenticated other than the selected module.

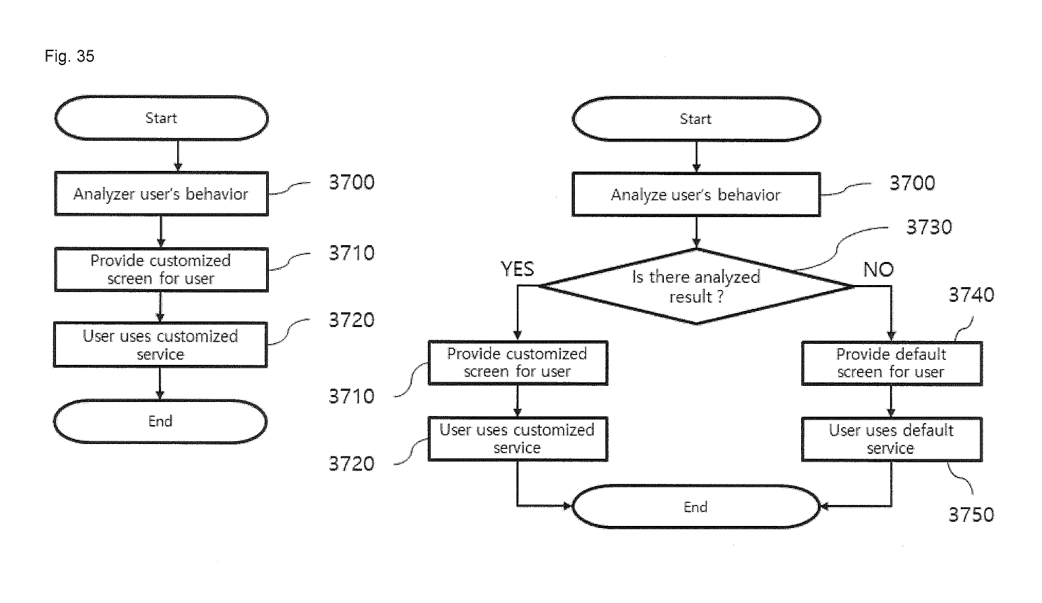

FIG. 35 is the flowchart of System and Method for Modular Communication that shows service analysis of usage in a peer to peer communication in browser-to-mobile (vice versa) or mobile-to-mobile applications method. The service continuously analyzes user's usage behavior 3700 such as which module the user uses more often, interaction with the modules, etc. With the continuous analysis of user usage behavior, the service will customize the module layout on the screen for user 3710. For instance, if user uses message module more often, then the message module will have priority in the sequence of placement of modules not the screen. Upon establishing connection, the user will use the customized layout of the service 3720. The service will analyze usage, but if there's no usage data, then the service will provide default module layout of the service 3740. The user will use the default layout 3750.

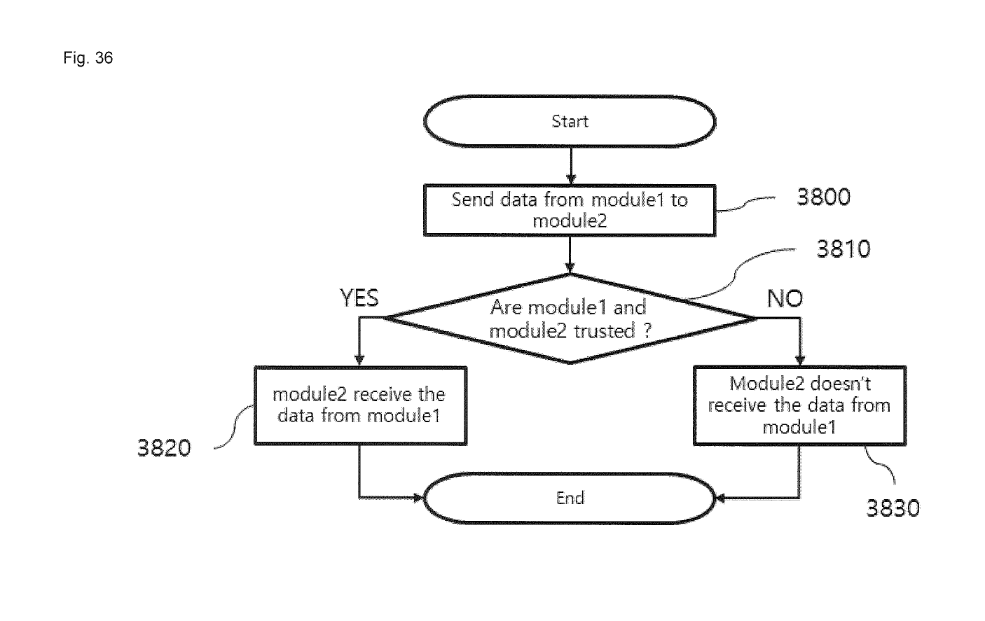

FIG. 36 is the flowchart of System and Method for Modular Communication that shows trust between modules in a peer to peer communication in browser-to-mobile (vice versa) or mobile-to-mobile applications method. User sends data from module1 to module2 3800. The service will check if module1 and module2 share the same data 3810. If yes, then module2 will receive data from module2 3820. If no, then module2 will not receive the data from module1 3830. For instance, a message will be shared in speech-to-text module, message module, translation module, but GPS module will not trust the message data.

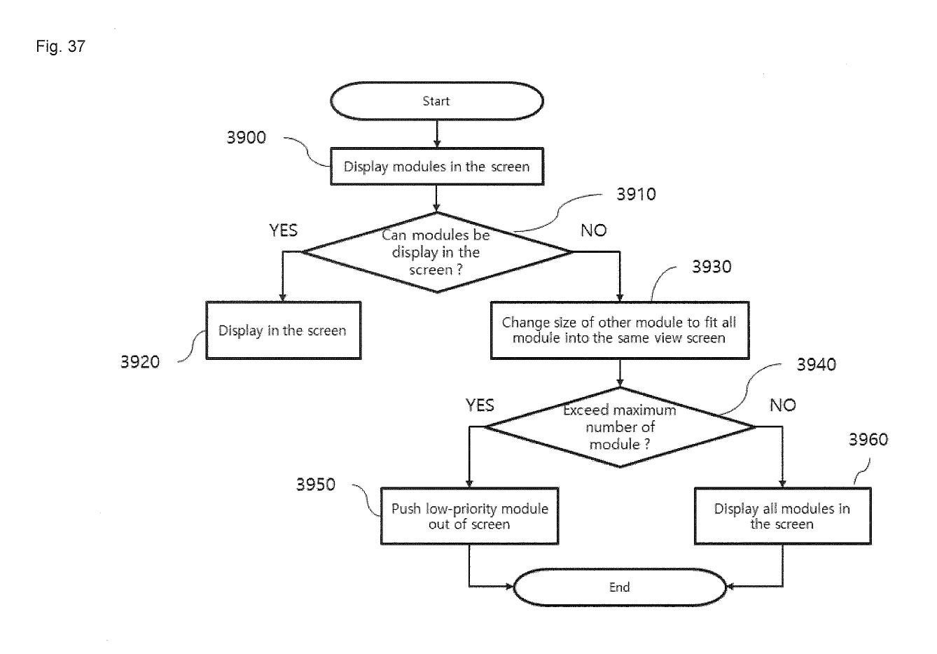

FIG. 37 is the flowchart of System and Method for Modular Communication that shows the module display fit and adjustment capability on 1-page screen view in a peer to peer communication in browser-to-mobile (vice versa) or mobile-to-mobile applications method. Default number of modules display on the screen 3900. The service will see if the modules can be displayed in the screen 3910. If yes, then all the modules will display in the viewing screen 3920. If no and there's more modules that needs to fit onto 1 screen for user view, then the service will adjust the size of other modules in order to keep all modules viewable on 1 screen for the user 3930. If the number of modules exceed the maximum number of modules 3940 on the screen, then the service will push low-priority modules out of the viewing screen for user 3950. The service continuously analyzes user usage behavior to produce the priority list of the modules. If the number of modules doesn't exceed maximum number of modules, then the service will display all modules in the screen 3920.

In the case of a module size change 3930 that exceeds the maximum number of modules allowed to be shown 3940 in FIG. 37, modules will disappear off the screen following a priority protocol 3950, or divide following a preset protocol.

For example in FIG. 32, if a module of size 2×4 is resized to fill the screen's maximum quota and another module is to be added, a module of low priority may be removed to make way. Alternatively, an already present module's space may be dynamically divided to allow for the new module.

In other words, it is possible for a screen to contain 7 modules of equal size, or 2 modules taking up half the screen respectively.

It is also possible to display more modules on screen by dividing the minimum module size.

It should be noted that the priority of modules takes into account frequency of usage and the history of use, discarding those of low use and old use first.

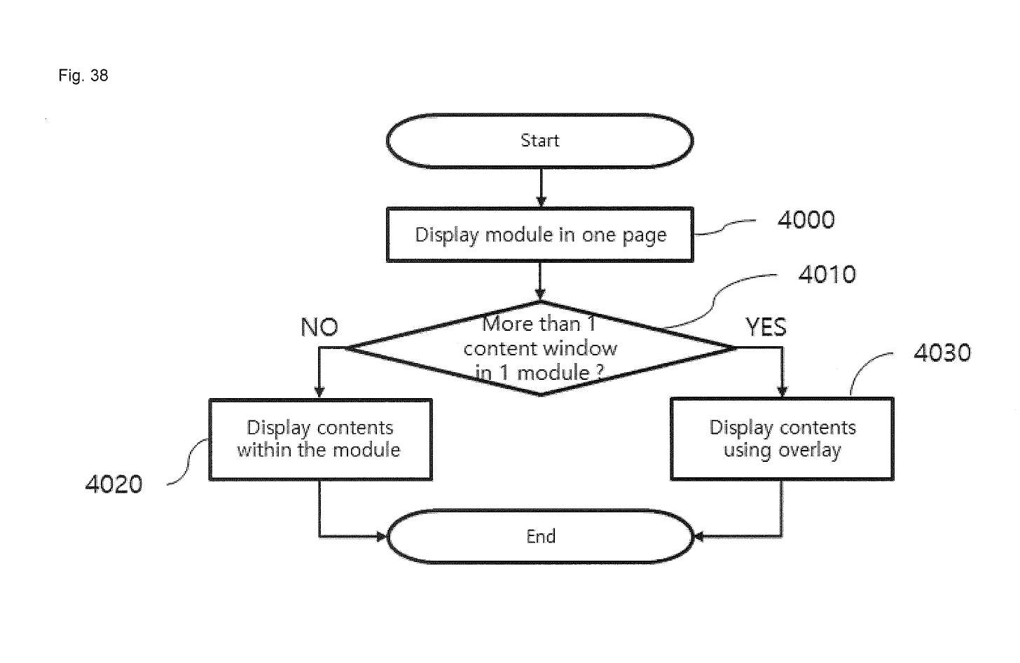

FIG. 38 is the flowchart of System and Method for Modular Communication that shows content window in a module in a peer to peer communication in browser-to-mobile (vice versa) or mobile-to-mobile applications method. The service displays modules on 1 page 4000. The service checks if there is more than 1 content window in 1 module 4010. If no, then module only has 1 content window in the 1 module and will display as normal 4020. If there is more than 1 content window in 1 module i.e. 2 or 3 content windows, then the module will display the additional content window by using overlay 4030. Overlay is the process of laying a content window on top of a content window. For instance, in video call module, there can be a small window that displays user1 while the bigger window in the same module displays user2.

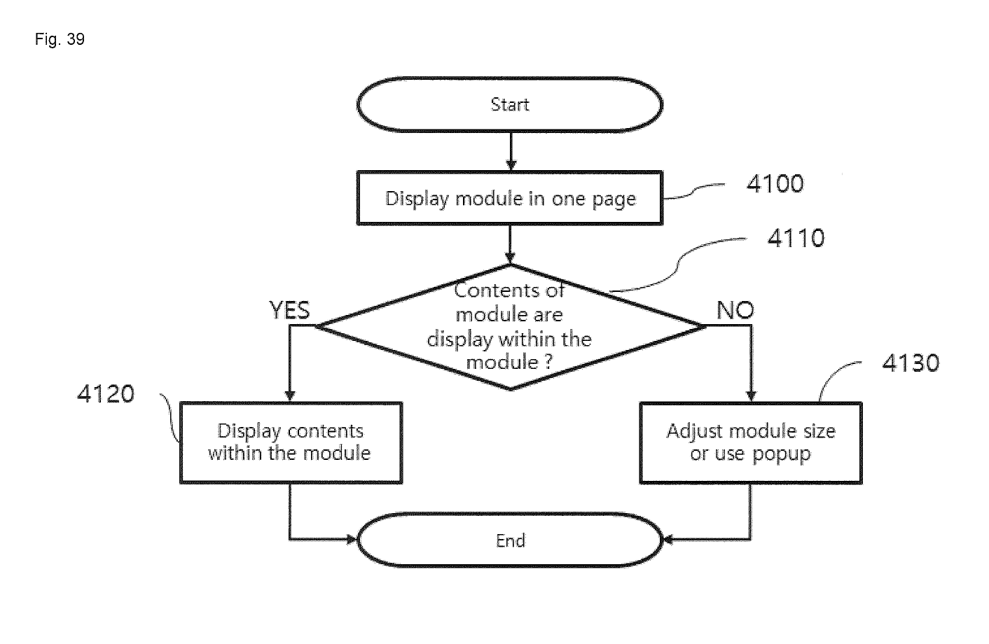

FIG. 39 is the flowchart of System and Method for Modular Communication that shows module view adjustment in a peer to peer communication in browser-to-mobile (vice versa) or mobile-to-mobile applications method. The service displays modules one 1 page 4100. The service checks if the contents of module are displayed within the module 4110. If yes, then the module display the content within the module as normal 4120. If no and portion of content in the module is missing due to small size of module, then 4130 user can display the contents of that module by adjusting module size i.e. widescreen, full screen. By adjusting module size, the other modules will dynamically move down the screen in sequential modular order. The user can also use pop-up to create a separate window 4130.

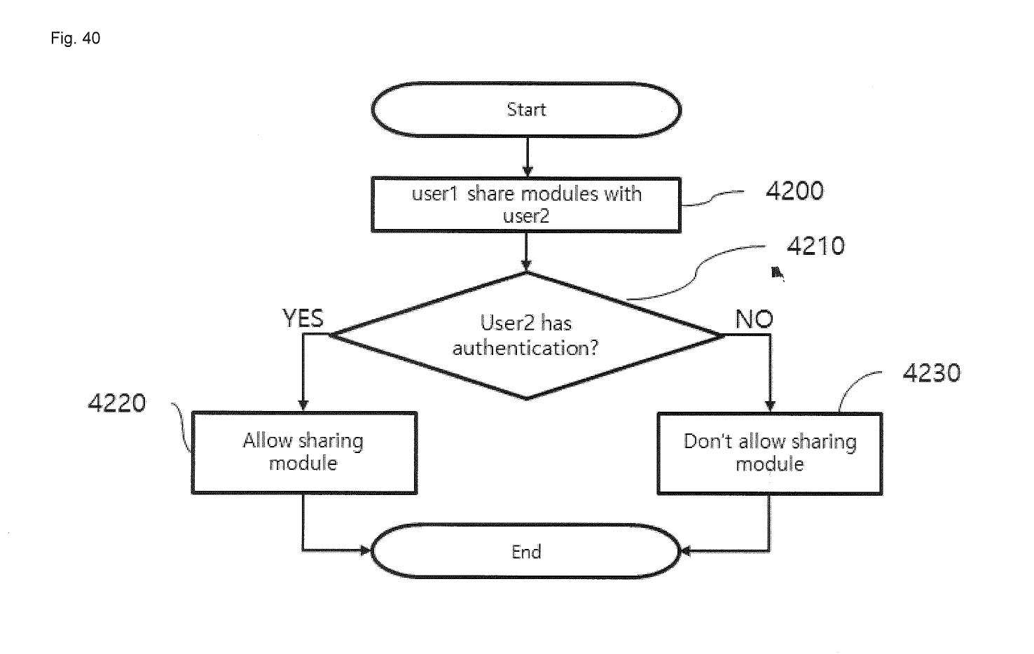

FIG. 40 is the flowchart of System and Method for Modular Communication that shows module sharing authentication in a peer to peer communication in browser-to-mobile (vice versa) or mobile-to-mobile applications method. User1 attempts to share modules with user2 4200. The service checks if user2 has the authentication to the module 4210. If yes, then user1 can share the modules content with user2 4220. If no, then user2 will not be able to see user1's shared module content 4230.

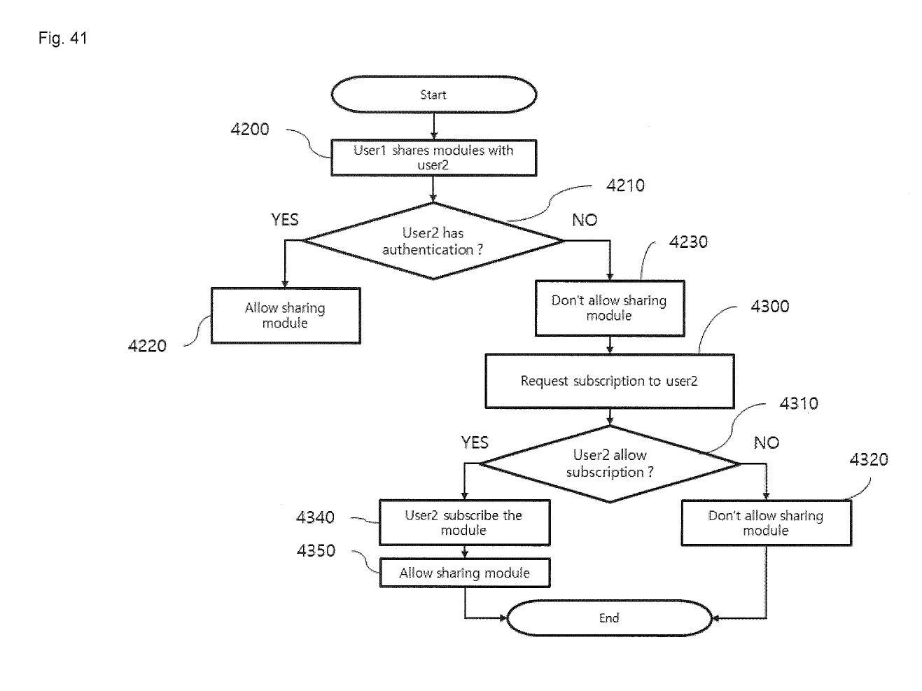

FIG. 41 is the flowchart of System and Method for Modular Communication that shows module sharing authentication and subscription in a peer to peer communication in browser-to-mobile (vice versa) or mobile-to-mobile applications method. User1 attempts to share modules with user2 4200. The service checks if user2 has the authentication to the module 4210. If yes, then user1 can share the modules content with user2 4220. If no, then user2 will not be able to see user1's shared module content 4230. In this case, user2 request authentication subscription to the module 4300. The service checks if user2 is allowed subscription 4310. If yes, then user2 subscribes to the module and can see the shared content from used , 4340, 4350. If no, then no sharing of module 4320.

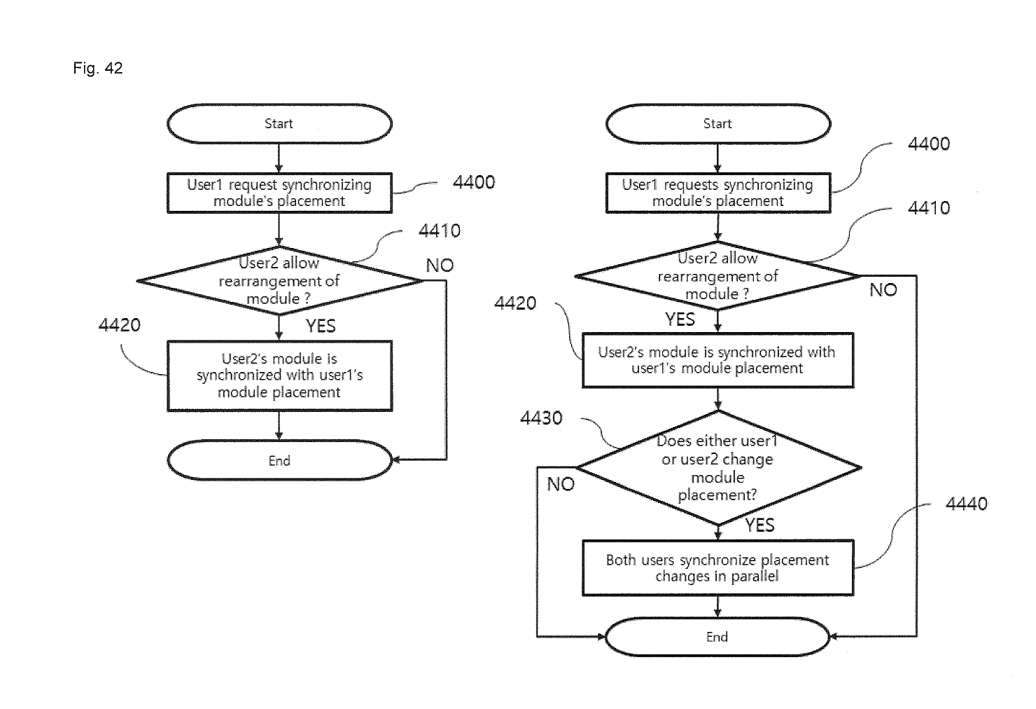

FIG. 42 is the flowchart of System and Method for Modular Communication that shows module synchronization capability in a peer to peer communication in browser-to-mobile (vice versa) or mobile-to-mobile applications method. User1 requests synchronizing module's placement with another user 4400. The service checks if user2 allow rearrangement of modules 4410. If yes, then user2's modules is synchronized with user1's module placement 4420. If no, then the synchronization of modules between the users does not occur. Once the synchronization occurs, if either user makes placement changes 4430, the change occurs in parallel with other user 4440.

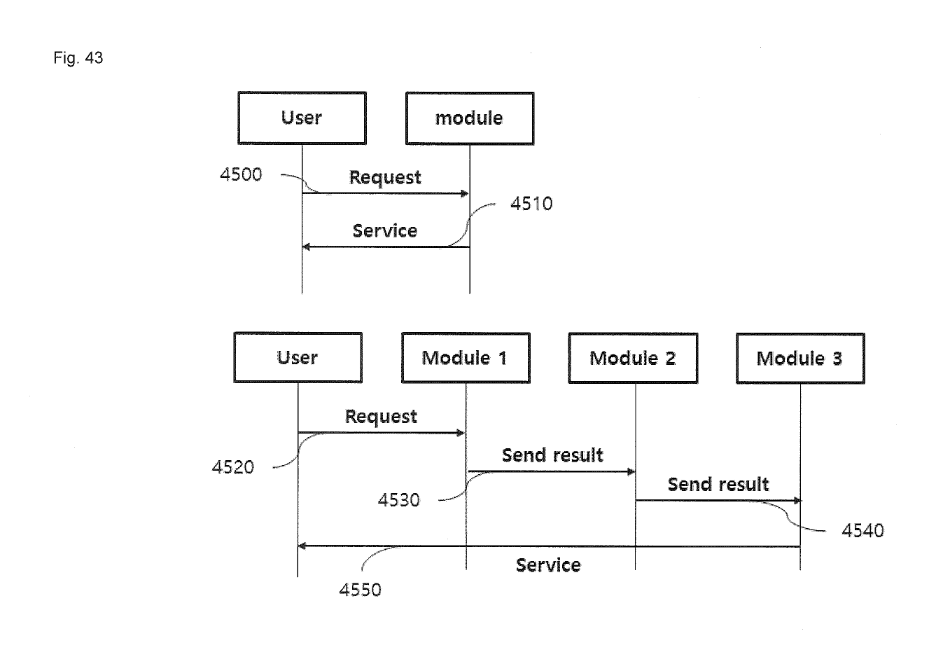

FIG. 43 is the data flow diagram of System and Method for Modular Communication that shows data flowing in the service in a peer to peer communication in browser-to-mobile (vice versa) or mobile-to-mobile applications method. User request 4500 interaction with module, which the module responds with service 4510. User request interaction 4520 with module1. Module1 sends result to module2 4530. Module2 sends result to module3 4540. Module3 provides service to user 4550.

Above description is merely an exemplary description of the technical spirit of the present invention, and various modifications, changes, and substitutions are possible for a person of skill in the art within the scope without deviating from the fundamental characteristics of the present invention.

Therefore, the exemplary embodiment and the accompanying drawings disclosed in the present invention is for explanation and not for limiting the technical spirit of the present invention, and the scope of the technical spirit of the present invention is not limited by these exemplary embodiments and the accompanying drawings. The scope of protection of the present invention must be interpreted according to the following claims, and it must be interpreted in such a way that all the technical spirits within the equivalent scope of the present invention are included in the scope of the rights of the present invention.

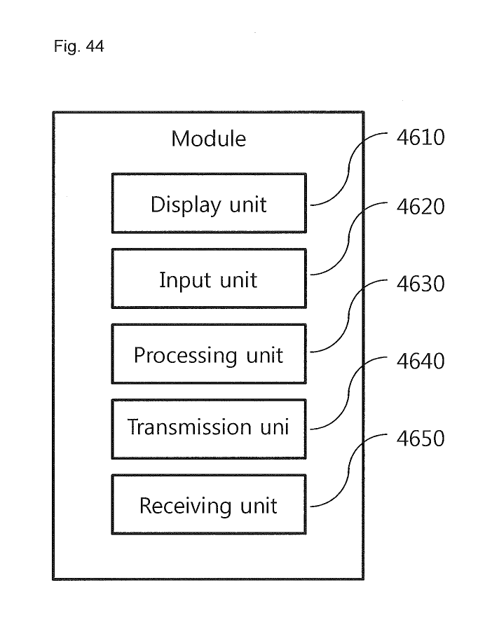

FIG. 44 is the block diagram of a module 4600 for a system for modular communication comprising a display unit 4610, an input unit 4620, a processing unit 4630, a transmission unit 4640 and a receiving unit 4650 according to the present invention. This module may be used for performing the above-described method for modular communication according to the present invention.

The display unit 4610 presents UI data according to at least one module selected by the user. The display unit 4610 displays multiple modules on a single screen according to a predetermined protocol of the single screen dividing. The display unit 4610 displays multiple modules, in the case the modules exceed the maximum threshold through the predetermined protocol of the single screen dividing, the modules are rearranged and or divided according to usage frequency and history.

The input unit 4620 is used for inputting the data by the user using a presented UI. The processing unit 4630 processes the input data according to the interface of module. The transmission unit 4640 sends the processed data to another user. The transmission unit 4640 sends the data via user command or by a predetermined protocol to another user. The receiving unit 4650 receives the processed data from said another user.

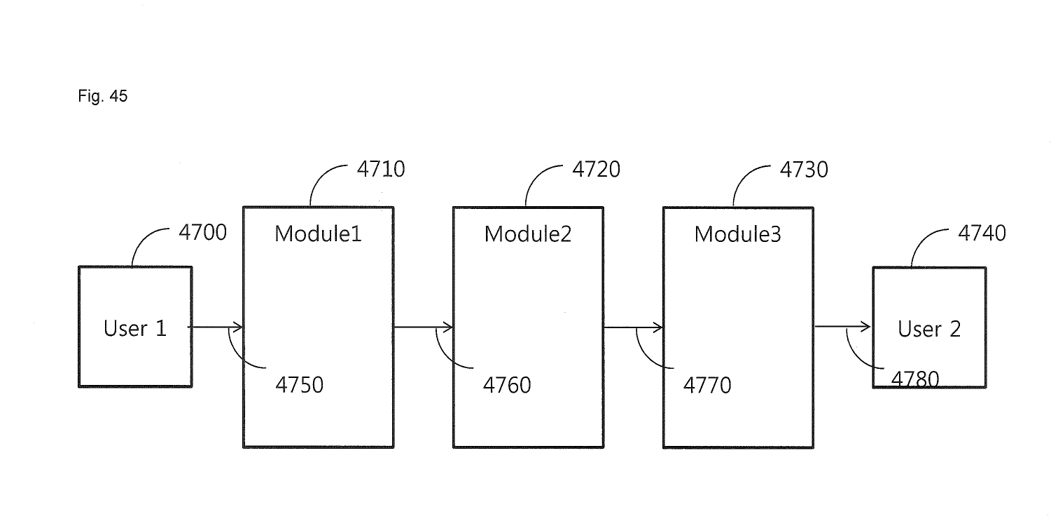

FIG. 45 is the block diagram of a system for modular communication that includes a combination of predetermined unit modules 4710, 4720 and 4730 according to the present invention. This system may be used for performing the above-described method for modular communication according to the present invention.

Each of the unit modules such as Module1 4710, Module2 4720 and Module3 4730 follows a protocol to interface with other unit module. This system may be used for performing the above-described method for modular communication according to the present invention.

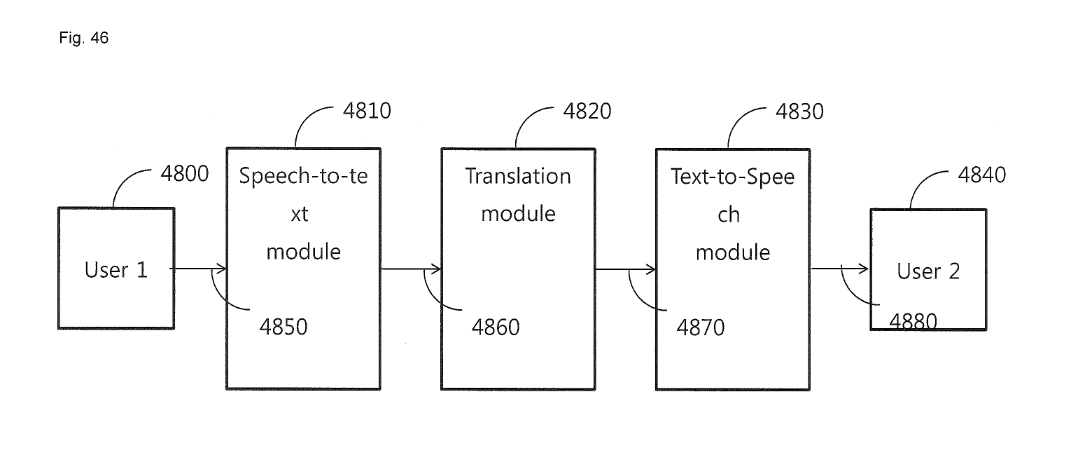

FIG. 46 is the block diagram of a system for modular communication that includes a module comprising a speech-to-text module 4810, a translation module 4820 and a text-to- speech module 4830. The system shown in FIG. 46 is an exemplary embodiment of the system shown in FIG. 45, wherein Module1 4710, Module2 4720 and Module3 4730 of FIG. 45 are replaced by the speech-to-text module 4810, the translation module 4820 and the text-to-speech module 4830.

The speech-to-text module 4810 converts speech input as text output. The translation module 4820 translates the aforementioned text output. The text-to-speech module 4830 converts text input as speech output.

The speech-to-text module 4810 utilizes the user's system settings or system environmental data of user terminal to detect the language to convert speech data into text data.

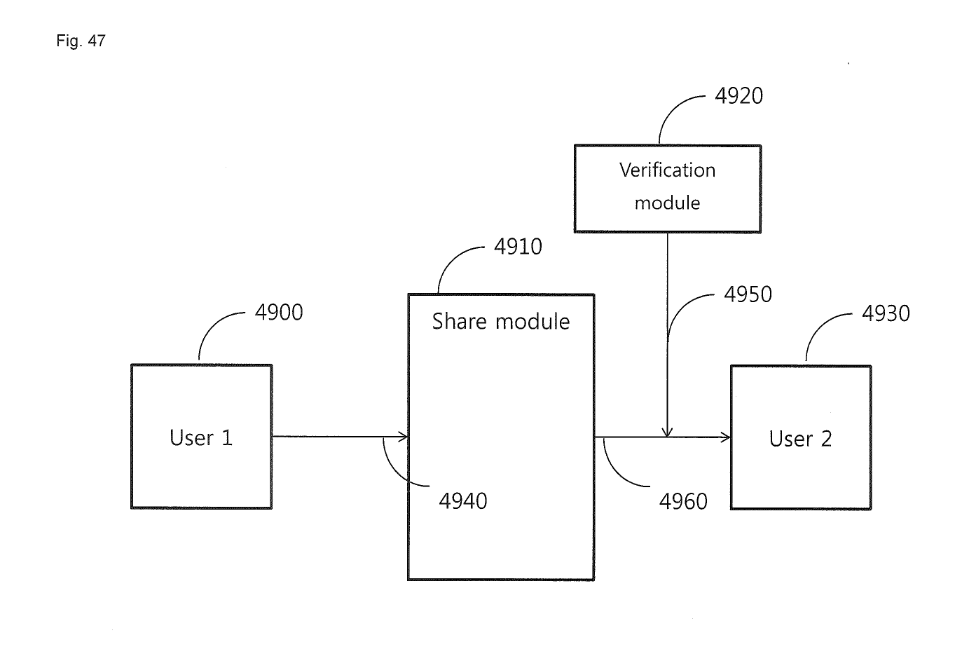

FIG. 47 is the block diagram of another system for modular communication that includes a share module 4910 and a verification module 4920 according to the present invention. This system may be used for performing the above-described method for modular communication according to the present invention.

The system includes a video media sharing module comprising the verification module 4920 that authenticates the share for access authorization. In the case of ungranted access, the verification module 4920 brings up the appropriate registration page within the module UI itself. A verified or otherwise newly authenticated user's video playback is synced. The video media sharing module provides appropriate translated captions for the video media by analyzing the respective user's settings or system environment information of user terminal.

What is claimed is:

1. A system for modular communication comprising:
a display unit presenting UI data according to at least one module selected by the user;
an input unit by which said user inputs the data using a presented UI;
a processing unit processing said input data according to the interface of module;
a transmission unit said processed data is sent to another user; and
a receiving unit said processed data is received from another user.

2. The System for modular communication according to claim 1, said module comprising a combination of an predetermined unit module, it follows a protocol to interface with other unit module.

3. The System for modular communication according to claim 2,
wherein said module is a translation module that comprising:
a speech-to-text module converting speech input as text output;
a translation module translating the aforementioned text output; and
a text-to-speech module converting text input as speech output.

4. The System for modular communication according to claim 3,
wherein said speech-to-text module utilizes the user's system settings or system environmental data of user terminal to detect the language to convert speech data into text data.

5. The System for modular communication according to claim 1,
wherein said transmission unit sends the data via user command or by a predetermined protocol to another user.

6. The System for modular communication according to claim 1,
wherein said module is a video media sharing module that comprising:
a verification module that authenticates the share for access authorization,
said verification module that in the case of ungranted access, brings up the appropriate registration page within the module UI itself.

7. The System for modular communication according to claim 6,
wherein a verified or otherwise newly authenticated user's video playback is synced.

8. The System for modular communication according to claim 7,
said video media sharing module providing appropriate translated captions for the video media by analyzing the respective user's settings or system environment information of user terminal.

9. The System for modular communication according to claim 1,
wherein the display unit displays multiple modules on a single screen according to a predetermined protocol of the single screen dividing.

10. The System for modular communication according to claim 9,
the display unit displaying multiple modules, in the case the modules exceed the maximum threshold through the predetermined protocol of the single screen dividing, the modules are rearranged and or divided according to usage frequency and history.

11. A method for modular communication, comprising:
connecting communication service between a sender and a recipient;
receiving words spoken by the sender through a microphone during connection of the communication service;
displaying the words in a sender-side message box;
transmitting a message including the words from the sender to the recipient; and
displaying the message in a recipient-side message box.

12. The method according to claim 11, further comprising:
translating the words into other language, and displaying the translated words in said other language in the sender-side message box.

13. The method according to claim 12, further comprising:
translating the words into a designated language, and displaying the translated words in the designated language in the recipient-side message box.

14. A method for modular communication, comprising:
connecting communication service between a sender and a recipient;
receiving words spoken by the sender through a microphone; and
automatically displaying an original message including the words and a translated message including translated words corresponding to the words translated into other language.

15. A method for modular communication, comprising:
sharing a module for User1 with User2;
verifying whether the User2 is authenticated;
allowing sharing of the module if the User2 is authenticated; and
not allowing the sharing of the module if the User2 is not authenticated.

16. The method according to claim 15, further comprising:
sending a request for subscription to the User2;
receiving an answer whether to allow the subscription from the User2;
processing the subscription of the User2 to the module and allowing the sharing of the module if the answer is allowing the subscription; and
not allowing the sharing of the module if the answer is not allowing the subscription.

17. A method for modular communication, comprising:
receiving a request for synchronization of module arrangement from User1;
receiving an answer whether to allow the module rearrangement from User2;
rearranging a module of the User2 such that the module arrangement of the User2 is same as the module arrangement of the User1 if the answer is allowing the module rearrangement; and
not rearranging the module of the User2 if the answer is not allowing the module rearrangement.

18. The method according to claim 17, further comprising:
verifying whether the module arrangement of the User1 or the User2 is changed; and
synchronizing the module arrangement of the User1 and that of the User2 with each other if the module arrangement of the User1 or the User2 is changed.
